(19) United States
(12) Patent Application Publication
(10) Pub. No.: US 2026/0279376 A1
(43) Pub. Date: Sep. 17, 2026

(54) SYSTEM

(71) Applicant: SoftBank Group Corp., Tokyo (JP)

(72) Inventor: Kenta KAWATA, Tokyo (JP)

(73) Assignee: SoftBank Group Corp., Tokyo (JP)

(21) Appl. No.: 19/549,127

(22) Filed: Feb. 25, 2026

Related U.S. Application Data
(60) Provisional application No. 63/769,922, filed on Mar. 11, 2025.

(51) Int. Cl. G10L 21/0232; G06F 40/40; G06N 3/0475; G10L 21/0216; G10L 21/034; G10L 21/0364; G10L 21/043; G10L 21/057; G10L 25/63

(52) U.S. Cl. CPC G10L 21/0232; G06F 40/40; G06N 3/0475; G10L 21/034; G10L 21/0364; G10L 21/043; G10L 21/057; G10L 25/63; G10L 2021/02166

(57) ABSTRACT

A system comprising a processor, the processor is configured to: control a microphone unit to capture external audio and generate audio data corresponding to the external audio; analyze the audio data by using a generative artificial intelligence model and adjust at least one of tone, volume, and pitch of the audio data to convert the data into optimized audio for a user; control an output unit to provide processed audio data to the user based on the optimized audio; communicate with a generative artificial intelligence model on a cloud server via a fifth generation (5G) communication network and cooperate with the generative artificial intelligence model to process the audio data in real time; convert important audio information for a hearing-impaired user into at least one of visual information and haptic information; and cause the output unit to output the at least one of the visual information and the haptic information.

### CROSS-REFERENCE TO RELATED APPLICATION

This application is based on and claims priority under 35 USC 119 (e) from U.S. Provisional Application No. 63/769,922 filed on Mar. 11, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional audio assistance systems and hearing support devices have several limitations in environments where background noise is high, where rapid changes in acoustic conditions occur, or where real-time responsiveness is required. For example, in educational environments such as classrooms, students often have difficulty clearly hearing a teacher's voice due to surrounding noise and insufficient control of tone, volume, and pitch. Known systems generally apply fixed amplification or simple filtering, and therefore fail to provide individually optimized audio that reflects user-specific hearing characteristics and context. Furthermore, existing systems do not sufficiently address the needs of hearing-impaired users in public spaces such as railway stations, public facilities, or outdoor event venues. In such environments, important audio information, including emergency announcements and siren sounds, may not be reliably perceived by hearing-impaired users. Conventional devices typically focus only on audio amplification and do not flexibly convert important audio information into visual or haptic signals in real time.

In addition, many current solutions are not designed to take full advantage of high-speed, low-latency communication such as fifth generation (5G) networks. As a result, it is difficult to offload complex processing, including generative artificial intelligence processing, to cloud servers while maintaining real-time performance. This prevents the use of advanced AI-based analysis and optimization for live audio, including fine-grained adjustment of tone, volume, and pitch, and real-time transformation of audio information into multimodal outputs. Accordingly, there is a need for a system that: (i) captures external audio with high accuracy, (ii) uses generative artificial intelligence to analyze and optimize audio characteristics such as tone, volume, and pitch in real time, (iii) cooperates with a cloud-based AI via a 5G communication network to perform high-level processing with low latency, and (iv) converts important audio information for hearing-impaired users into visual and/or haptic information so that such users can reliably receive critical announcements and alerts in various environments.

### SUMMARY

To solve the above-described problems, according to one aspect of the present invention, there is provided a system comprising a processor, wherein the processor is configured to control a microphone unit to capture external audio and generate audio data corresponding to the external audio, to analyze the audio data by using a generative artificial intelligence model, and to adjust at least one of tone, volume, and pitch of the audio data so as to convert the audio data into optimized audio for a user. The processor is further configured to control an output unit to provide processed audio data to the user based on the optimized audio.

The processor is also configured to communicate with a generative artificial intelligence model on a cloud server via a fifth generation (5G) communication network and to cooperate with the generative artificial intelligence model on the cloud server to process the audio data in real time. By leveraging the high speed and low latency of the 5G communication network, complex AI-based analysis and enhancement of audio data can be performed on the cloud while maintaining real-time responsiveness to the user.

Additionally, the processor is configured to convert important audio information for a hearing-impaired user into at least one of visual information and haptic information, and to cause the output unit to output the at least one of the visual information and the haptic information. In an educational environment, for example, the processor can adjust at least one of tone and volume of a teacher's voice included in the audio data to make the teacher's voice easier to hear, and can perform noise canceling processing on the audio data to remove unnecessary noise. The processor can further detect specific sounds, such as a siren, and convert the detected sound into at least one of a visual signal and haptic feedback so that a hearing-impaired user can obtain important audio information.

Moreover, the processor is configured to control the output unit to provide audio information in an optimized form according to settings and needs of the user by providing conversion results of the audio data in real time as feedback. The processor is able to customize at least one of a visual signal and haptic feedback output by the output unit based on the settings and needs of the user, and to use the fifth generation (5G) communication network to process the audio data with low latency and high speed so that the user can smoothly receive the audio. Through these means, the system achieves real-time, context-aware, and user-specific optimization of audio, and reliable delivery of important sound information to both hearing and hearing-impaired users.

The term “system” refers to an integrated combination of hardware and software components, including at least a processor, a microphone unit, and an output unit, which cooperatively perform the functions defined in the claims.

The term “processor” refers to one or more hardware processing units, such as a CPU, GPU, DSP, ASIC, FPGA, or a combination thereof, which execute instructions to perform the operations and control functions described in the claims.

The term “microphone unit” refers to one or more microphones, including but not limited to single microphones, microphone arrays, directional microphones, and omnidirectional microphones, and associated circuitry configured to capture external audio and generate corresponding audio signals.

The term “external audio” refers to sound present in an environment outside the system, including but not limited to human speech, environmental noise, alarm sounds, and other acoustic events that can be captured by the microphone unit.

The term “audio data” refers to digital data representing sound, which is obtained by converting captured audio signals from the microphone unit into a digital format suitable for processing by the processor.

The term “output unit” refers to one or more devices or components configured to provide information to a user, including but not limited to speakers, earphones, headphones, display devices, indicator lights, and haptic actuators.

The term “generative artificial intelligence model” refers to a machine learning model, such as a neural network or other AI model, that generates or transforms data, and is configured to analyze audio data and adjust characteristics such as tone, volume, and pitch, or to produce visual or haptic outputs based on the audio data.

The term “analyze the audio data” refers to performing computational operations on the audio data, including but not limited to feature extraction, classification, separation, enhancement, or transformation, in order to determine characteristics of the audio and enable subsequent processing.

The term “tone” refers to a perceptual or acoustic characteristic of audio related to its spectral content, timbre, or equalization, and includes adjustment of frequency components to influence how the audio is perceived in terms of quality or color.

The term “volume” refers to a level or magnitude of audio signal amplitude, perceived as loudness by a user, and includes adjustments such as amplification, attenuation, or normalization of the audio signal level.

The term “pitch” refers to the perceived fundamental frequency of an audio signal, particularly speech, and includes operations that shift or modify the fundamental frequency and related harmonics.

The term “optimized audio for a user” refers to audio that has been adjusted in one or more characteristics, such as tone, volume, and pitch, based on contextual information, user settings, or hearing characteristics, with the goal of improving intelligibility, clarity, or comfort for that specific user.

The term “processed audio data” refers to audio data that has been subjected to one or more operations by the processor, including analysis, enhancement, transformation, or optimization, before being provided to the user.

The term “cloud server” refers to one or more remote computing resources accessible via a communication network, which execute a generative artificial intelligence model and cooperate with the system's processor to process audio data.

The term “fifth generation (5G) communication network” refers to a mobile communication network that conforms to 5G standards and provides high-speed, low-latency wireless data transmission between the system and a cloud server or other remote resources.

The term “communicate with a generative artificial intelligence model on a cloud server” refers to exchanging data, including audio data, analysis results, and control information, between the processor and the cloud server over a communication network so as to enable cooperative processing by the generative artificial intelligence model.

The term “real time” refers to processing and response of audio data with a latency sufficiently low that a user can perceive the resulting output as substantially simultaneous with the original sound, such as during live speech or announcements.

The term “hearing-impaired user” refers to a user who has a partial or total loss of hearing ability and may require alternative or enhanced modalities, such as visual or haptic signals, to reliably obtain information that is normally conveyed by sound.

The term “important audio information” refers to audio content that is significant for safety, communication, or understanding of a situation, including but not limited to emergency announcements, sirens, alarms, warnings, and essential speech messages.

The term “visual information” refers to information provided to the user through visual means, including but not limited to text, icons, graphics, visual alerts, color changes, or screen flashes displayed on a display device or indicator.

The term “haptic information” refers to information provided to the user through tactile or vibrational feedback, including but not limited to vibration patterns, pulses, or other mechanical stimuli generated by a haptic actuator.

The term “visual signal” refers to a specific visual output pattern, such as a change in color, brightness, flashing pattern, or displayed symbol, that is generated to represent or indicate certain audio information or system status.

The term “haptic feedback” refers to tactile sensations, such as vibration or pressure pulses, generated by the system to notify or alert the user about particular audio events or information.

The term “educational environment” refers to an environment in which teaching or learning activities occur, including but not limited to classrooms, lecture halls, training rooms, and similar spaces where a teacher or speaker addresses one or more listeners.

The term “teacher's voice” refers to speech produced by a teacher, instructor, or presenter in an educational environment, which is included in the audio data and may be subject to enhancement or adjustment.

The term “noise canceling processing” refers to processing techniques that reduce or remove unwanted sound components from audio data, including but not limited to adaptive filtering, spectral subtraction, or other algorithms designed to suppress background noise.

The term “siren” refers to a sound pattern typically used in emergency situations, such as those produced by police cars, ambulances, fire engines, or alarm systems, which is characterized by recognizable frequency and temporal patterns.

The term “settings and needs of the user” refers to user-specific configuration parameters, preferences, hearing characteristics, and usage requirements that influence how audio, visual, and haptic outputs are generated and presented by the system.

The term “conversion results of the audio data” refers to outputs obtained after processing the audio data, including but not limited to enhanced audio, translated audio, transcribed text, or generated visual or haptic signals.

The term “low latency and high speed” refers to communication and processing characteristics in which data transfer and computation occur quickly enough to support substantially immediate or near-immediate responses, suitable for live or interactive use.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

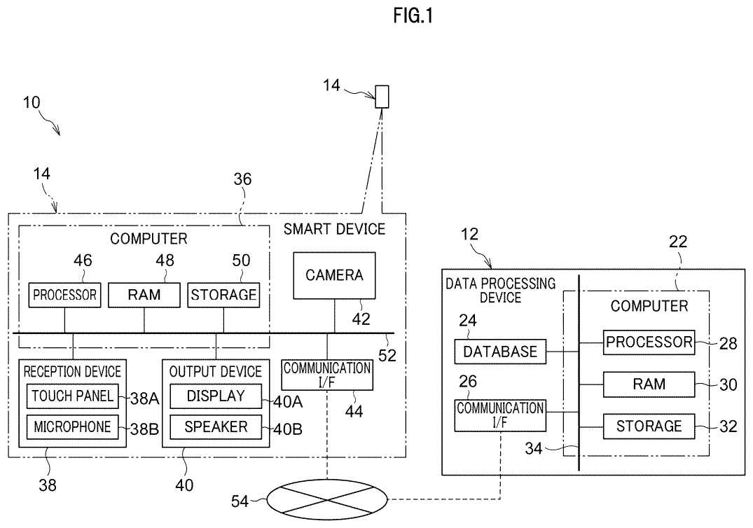

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34.

The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

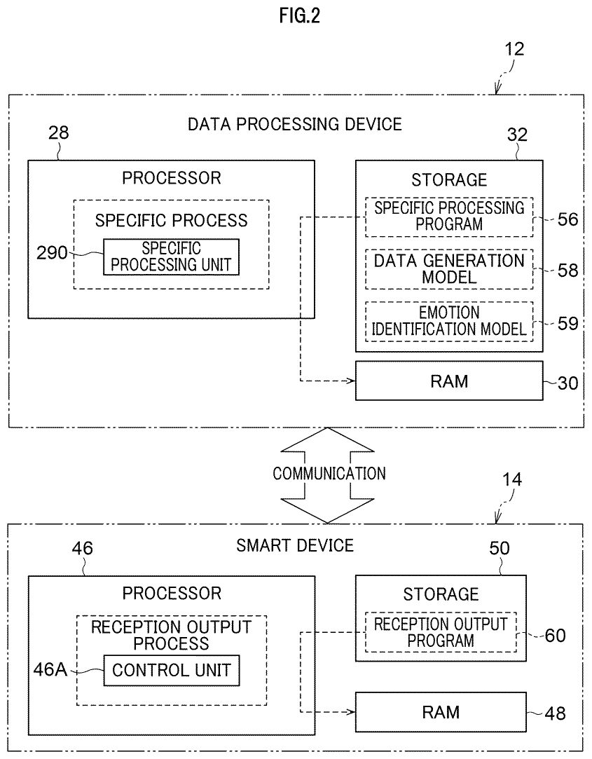

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented audio support systems for hearing-impaired users or users in noisy environments typically rely on fixed digital signal processing pipelines, static equalizer profiles, and pre-defined user interface behaviors. Such systems are often implemented as rigid software components that apply noise suppression, equalization, and volume adjustment according to hard-coded parameters or coarse user-selectable presets. As a result, the underlying computer technology lacks the capability to flexibly adapt its low-level signal processing and multimodal output control logic to diverse acoustic scenes, individual hearing characteristics, and changing user intents in real time.

In particular, known systems generally do not allow an audio processing pipeline to be dynamically reconfigured on the basis of natural-language instructions. While generative AI models have recently become available, conventional systems either use such models for content generation at an application layer or treat them as separate services. They do not integrate generative AI models into the core control loop of audio capture, enhancement, recognition, translation, and output in a way that allows the generative AI models to issue structured control instructions that directly drive digital signal processing, event detection, and multimodal notification mechanisms. This separation leads to inefficiencies, increased latency, and limited adaptability of the computer system as a whole.

Furthermore, traditional audio support systems lack an architecture for converting unstructured acoustic scenes and user preferences into structured, machine-interpretable control parameters in a systematic and extensible manner. Existing implementations typically encode behavior in procedural code or static configuration files. They do not provide a mechanism in which a processor can: (i) compute detailed acoustic features; (ii) form prompt sentences including such features and user context; (iii) obtain, from a generative AI model, structured instruction information that specifies parameters for multiple processing modules; and (iv) apply those parameters to reconfigure signal processing components and output controllers in real time. As a consequence, the underlying computer technology for multimodal audio assistance remains brittle, difficult to maintain, and unable to leverage advances in generative modeling to improve core system performance.

In addition, current systems have limited capabilities for maintaining session- and user-specific processing strategies over time. They often store only coarse preferences such as overall volume or language selection, without recording fine-grained structured instruction sets that describe, for example, which frequency bands should be emphasized, what latency is acceptable, and how visual and haptic alerts should be patterned. This lack of persistent, structured configuration prevents the computer from learning from prior sessions and automatically optimizing subsequent processing conditions for the same user or environment. Moreover, conventional architectures do not effectively exploit modern mobile communication networks to maintain real-time, bidirectional coordination between on-device capture/pre-processing and cloud-based generative processing. In many cases, audio streams, recognition results, and UI control messages are transmitted as separate, loosely synchronized channels without a defined logical multiplexing and adaptation mechanism. As network conditions fluctuate, such systems degrade in unpredictable ways, causing delayed or dropped notifications, desynchronized captions, and discontinuities in audio output.

Accordingly, there is a need for an improved computer-implemented system that tightly integrates generative AI models into the core audio processing and multimodal output control pipeline. Such a system should enable a processor to (1) derive detailed feature information from incoming audio; (2) construct and send prompt sentences to a generative AI model; (3) receive structured instruction information that specifies parameters and behaviors for signal processing, recognition, translation, and output; (4) execute these instructions in real time across both local and remote computing resources; and (5) store and reuse structured configurations for each user. By solving these problems, the invention aims to improve the functioning of the computer itself, yielding a more adaptive, efficient, and robust audio assistance platform that can operate under varying acoustic and network conditions while providing individualized support.

The specific processing by the specific processing unit 290 of the data processing device 12 in Example 1 is realized by the following means.

The present invention provides a server comprising a processor configured to receive, via a mobile communication network, audio data and associated metadata acquired by a terminal device, the metadata including at least one of user setting information and environment information; to perform signal analysis on the audio data to compute feature information including at least frequency information and loudness information; to generate a prompt sentence including the feature information and the user setting information; to supply the prompt sentence to a generative AI model and obtain, from the generative AI model, structured instruction information including at least one of a frequency band emphasis parameter, a noise suppression parameter, a loudness parameter, a pitch correction parameter, a language conversion parameter, a visual presentation parameter, and a haptic presentation parameter; to control a plurality of processing modules including at least one of an equalization module, a dynamic range control module, a pitch conversion module, a speech recognition module, a translation module, and a speech synthesis module, based on the structured instruction information so as to generate enhanced audio information and associated auxiliary information including at least one of text information, visual alert information, and haptic alert information; to multiplex and transmit, via the mobile communication network, the enhanced audio information, the text information, the visual alert information, and the haptic alert information as logically separated channels to the terminal device while monitoring at least one of latency and transmission quality and dynamically simplifying at least one of processing content and data amount in accordance with the structured instruction information and the monitored result; and to store, in an associated storage, the structured instruction information and the user setting information for each user session and to update, upon reception of an updated prompt sentence from the terminal device, the structured instruction information by re-invoking the generative AI model and applying the updated structured instruction information to subsequent processing of audio data in real time. This enables the computer system to transform unstructured audio and natural-language user inputs into structured, machine-interpretable control instructions that dynamically reconfigure low-level signal processing and multimodal output behavior, thereby improving adaptability, efficiency, and robustness of audio enhancement and notification functions under varying acoustic environments and network conditions while providing individualized support to users, including hearing-impaired users.

The term “system” refers to a combination of hardware and software components that cooperate to perform audio acquisition, processing, communication, and presentation functions as recited in the claims.

The term “processor” refers to one or more hardware processing units, such as a central processing unit, a digital signal processor, or a graphics processing unit, configured to execute instructions that implement the functionalities described in the claims.

The term “input apparatus” refers to any hardware device configured to capture external acoustic information, such as a microphone, a microphone array, or another sound-sensing device.

The term “external acoustic information” refers to sound originating from an environment outside the system, including speech, environmental noise, alarms, and other audio signals.

The term “audio data” refers to digital data representing acoustic information, including time-domain samples, frequency-domain representations, and derived feature data.

The term “signal processing” refers to computational operations applied to audio data, including filtering, noise reduction, beamforming, equalization, dynamic range control, pitch conversion, and other digital signal manipulation.

The term “environmental noise” refers to acoustic components unrelated to a target sound source, such as background chatter, mechanical noise, traffic noise, and other undesired sounds.

The term “acoustic source direction” refers to a spatial direction from which a particular sound originates, estimated using one or more microphones or equivalent sensors.

The term “time frame” refers to a segment of audio data having a finite duration, used as a unit for analysis or processing in the time or frequency domain.

The term “feature information” refers to numerical or symbolic descriptors derived from audio data, including frequency-related features, loudness-related features, and other signal characteristics.

The term “frequency information” refers to information representing the spectral content of audio data, such as power spectra, spectral envelopes, or frequency band energies.

The term “loudness information” refers to information representing perceived or physical sound level, such as energy, sound pressure level, or psychoacoustic loudness measures.

The term “user attribute information” refers to information describing characteristics or preferences of a user, including hearing ability, language preference, and profile identifiers.

The term “text information” refers to character-based data, including words, sentences, transcripts, captions, and other symbolic representations of content.

The term “prompt sentence” refers to a natural-language or structured text input supplied to a generative AI model, instructing the model how to control audio processing, translation, or output behavior.

The term “generative AI model” refers to a machine learning model configured to generate outputs, including text or structured control information, based on input data such as prompt sentences and contextual information.

The term “structured instruction information” refers to machine-interpretable data specifying control parameters and behaviors for processing modules and output modules, such as frequency band emphasis parameters, noise suppression parameters, loudness parameters, pitch correction parameters, language conversion parameters, visual presentation parameters, and haptic presentation parameters.

The term “frequency band emphasis parameter” refers to a value or set of values indicating how much to increase or decrease the gain of one or more frequency ranges in the audio data.

The term “noise suppression parameter” refers to a value or set of values controlling the degree and characteristics of operations that reduce environmental noise in the audio data.

The term “loudness parameter” refers to a value or set of values specifying target levels, gains, or dynamic behavior for controlling the perceived loudness of audio output.

The term “pitch correction parameter” refers to a value or set of values specifying how to modify the fundamental frequency or perceived pitch of speech or other sounds.

The term “language conversion parameter” refers to a value or set of values indicating source and target languages and conditions for translating textual or spoken content.

The term “visual presentation parameter” refers to a value or set of values specifying how information should be displayed, including text size, color, layout, alert style, and other visual attributes.

The term “haptic presentation parameter” refers to a value or set of values specifying how vibration or other tactile feedback should be generated, including intensity, pattern, and duration.

The term “equalization processing” refers to operations that adjust the gain of specific frequency components or bands in audio data.

The term “dynamic range control processing” refers to operations that modify the range between the quietest and loudest parts of audio data, including compression, expansion, limiting, and related techniques.

The term “pitch conversion processing” refers to operations that alter the perceived pitch of an audio signal, including pitch shifting and pitch scaling, with or without formant preservation.

The term “speech synthesis processing” refers to operations that generate synthetic speech audio from text information or intermediate symbolic representations.

The term “translation processing” refers to operations that convert text or speech content from one language to another.

The term “summarization processing” refers to operations that reduce the length or complexity of text or speech content while preserving essential information.

The term “enhanced audio information” refers to audio data that has been modified to improve intelligibility, clarity, or suitability for a particular user or environment.

The term “audio output apparatus” refers to a hardware component configured to produce audible sound, such as a loudspeaker, earphone, or headphone.

The term “display apparatus” refers to a hardware component configured to visually present information, such as a display panel, monitor, or wearable display.

The term “haptic output apparatus” refers to a hardware component configured to provide tactile feedback, such as a vibration motor or haptic actuator.

The term “vibration information” refers to data specifying characteristics of tactile feedback, including amplitude, frequency, pattern, and duration.

The term “mobile communication network” refers to a wireless communication infrastructure that supports data transmission between the system and an external information processing apparatus, including cellular networks and other wide-area networks.

The term “external information processing apparatus” refers to a computing system separate from the terminal device, such as a remote server or cloud platform, that executes at least a portion of the processing described in the claims.

The term “user setting information” refers to configuration data provided by a user, including environment type, listening purpose, preferred frequency band, target translation language, and notification mode.

The term “environment type” refers to a classification of the acoustic or usage context, such as classroom, public transportation facility, conference room, or outdoor event.

The term “listening purpose” refers to an intended use or goal of audio support, such as lecture comprehension, emergency detection, or real-time translation.

The term “preferred frequency band” refers to one or more frequency ranges specified by a user as important to emphasize or preserve.

The term “target translation language” refers to a language designated by a user or system as the output language for translation processing.

The term “notification mode” refers to a combination of modalities and styles by which alerts or information are provided, including audio, visual, and haptic forms.

The term “natural-language prompt sentence” refers to a human-readable sentence or phrase, written or spoken in a natural language, used to instruct a generative AI model regarding desired processing behavior or output.

The term “processing module” refers to a software or hardware component that performs a specific type of operation on data, such as equalization, dynamic range control, pitch conversion, speech recognition, translation, or speech synthesis.

The term “speech recognition module” refers to a processing module configured to convert speech audio into text information.

The term “translation module” refers to a processing module configured to convert text from one language to another.

The term “speech synthesis module” refers to a processing module configured to generate speech audio from text information.

The term “auxiliary information” refers to information associated with enhanced audio information, including text information, visual alert information, and haptic alert information.

The term “visual alert information” refers to data indicating that an event or condition should be signaled visually, including content, style, and timing of the alert.

The term “haptic alert information” refers to data indicating that an event or condition should be signaled via tactile feedback, including pattern, intensity, and timing.

The term “multiplexing” refers to combining multiple logical channels of data, such as audio data, text information, and control information, into a single transmission stream while preserving logical separation.

The term “logical channel” refers to a virtual or conceptual subdivision of a communication stream used to distinguish different types of data.

The term “latency” refers to the time delay between acquisition or generation of data and its delivery or presentation to a user.

The term “transmission quality” refers to characteristics of data transfer over a network, including bandwidth, error rate, jitter, and packet loss.

The term “processing content” refers to specific processing operations and their parameters applied to audio data or related information.

The term “data amount” refers to the size or volume of data transmitted or processed, typically measured in bits, bytes, or frames per unit time.

The term “user session” refers to a logically continuous period during which a particular user interacts with the system and during which processing conditions may be tracked and applied.

The term “updated prompt sentence” refers to a new or modified prompt sentence provided by a user or device to alter the behavior of the generative AI model and the resulting structured instruction information.

In one embodiment, a terminal, a server, and a user cooperate to implement the claimed system. The terminal includes a microphone array, a processor, a memory, a mobile communication interface, a display, an audio output apparatus, and a haptic output apparatus.

The server includes at least one central processing unit, at least one graphics processing unit, a memory, a mass storage device, and a network interface. The user operates an application executed on the terminal to configure profiles and to provide prompt sentences to a generative AI model running on the server.

Terminal uses a microphone array including a plurality of micro-electro-mechanical microphones to acquire external acoustic information. Terminal uses an operating system audio interface, such as an audio input application programming interface, to obtain digital audio data from the microphone array. Terminal converts analog signals into digital samples at a sampling frequency, for example 16 kHz or 48 kHz, and quantizes the samples at a bit depth, for example 16 bits per sample.

Terminal uses its processor to perform initial signal processing. Terminal executes a beamforming algorithm that calculates time differences of arrival between microphones, forms steering vectors toward estimated source directions, and linearly combines microphone channels to emphasize a main speaker direction and suppress other directions. Terminal uses a fast Fourier transform library to perform frequency-domain conversion on short frames of the audio data and computes an estimated noise spectrum based on long-term averaging of frames labeled as non-speech by a voice activity detector. Terminal subtracts the noise spectrum from the current spectrum and applies a spectral floor to prevent musical noise, thereby reducing stationary environmental noise such as air-conditioner noise or traffic noise.

Terminal encodes the processed audio data using a low-latency audio codec, such as a general-purpose audio compression standard, and assembles packets including compressed audio payloads and metadata. Terminal includes in the metadata a user identifier, a profile identifier, environment-type information, and, in some embodiments, an identifier of a prompt sentence that the user has selected or entered. Terminal transmits the packets to the server using a mobile communication network such as a cellular network conforming to a modern wireless standard. Terminal uses a transport protocol supporting streaming, such as a secure transmission control protocol-based or datagram-based protocol.

Server receives the audio packets through its network interface and uses a media framework, such as a general-purpose multimedia processing library, to decode the compressed audio into linear pulse-code-modulated data. Server stores the decoded audio in a circular buffer in a main memory to accommodate jitter and packet reordering. Server applies an internal resampling process to normalize the sampling frequency across different terminals.

Server uses a signal processing library, such as a numerical computation library and a scientific computing library, to compute feature information from the buffered audio. Server applies a short-time Fourier transform to obtain magnitude spectra. Server computes mel-spectrograms, mel-frequency cepstral coefficients, and energy-based loudness measures.

Server additionally computes pitch information using an autocorrelation-based estimator or an algorithm that estimates fundamental frequency by minimizing a difference function. Server aggregates these features into feature vectors associated with time indices.

Server forms text information that includes the feature information and user attribute information as fields. For example, server converts a subset of feature values into discretized tokens and concatenates them with tokens representing user hearing profile, environment type, and current listening purpose. Server constructs a prompt sentence in natural language that describes the acoustic context and the user's intent. Example prompt sentences include:

“Enhance the teacher's voice in this noisy classroom by boosting consonant frequencies and suppressing background chatter while keeping latency below 150 milliseconds.” “When a siren or emergency alarm is detected in the input audio, generate visual alerts and strong vibration patterns on the terminal until the alarm ends.”

“Translate the detected English speech into Japanese in real time and generate simplified speech suitable for a hearing-impaired high-school student, with large captions.”

“Emphasize frequency components between 2 kHz and 4 kHz in the main speaker's voice and reduce continuous noise components below 300 Hz to improve intelligibility.”

Server supplies the prompt sentence and, in some embodiments, an additional machine-readable representation of the feature information to a generative AI model. Server stores the generative AI model in a memory and executes the model using a neural network framework such as a tensor computation library on the graphics processing unit. In one embodiment, the generative AI model is a transformer-based sequence model having a plurality of self-attention layers, feed-forward layers, layer normalization layers, and learned embedding tables. Server configures the model with parameters such as number of layers, number of attention heads, hidden dimension size, and context length.

Server trains the generative AI model prior to deployment using a dataset consisting of pairs of input texts (prompt sentences plus context descriptors) and output texts representing structured instructions. Server uses supervised learning with a cross-entropy loss function computed between predicted tokens and target tokens. Server updates the model's weights using a gradient-based optimization algorithm, such as stochastic gradient descent with an adaptive learning rate. Server optionally uses data augmentation methods, such as paraphrasing prompt sentences or adding noise to feature descriptors, to improve generalization.

Server constrains the generative AI model's output to a pre-defined structured format. In one embodiment, server uses a grammar or template that restricts the model to output fields such as “frequency_band_emphasis,” “noise_suppression_level,” “target_loudness,” “pitch_shift,” “source_language,” “target_language,” “visual_alert_style,” “haptic_pattern,” and “allowed_latency.” Server post-processes the generated text by parsing it according to the grammar to obtain structured instruction information as a set of key-value pairs or a data structure stored in memory.

Server uses the structured instruction information to control a plurality of processing modules. Server configures an equalization module by mapping the frequency band emphasis values to filter coefficients of digital filters. Server generates biquad filter parameters for each band to realize specified gains and bandwidths. Server configures a dynamic range control module by setting threshold, ratio, attack time, and release time parameters for a compressor or expander. Server controls a pitch conversion module, which may be implemented using a phase vocoder or a neural pitch-shifting network, by supplying a pitch_shift parameter and enabling or disabling formant preservation.

Server uses a speech recognition module to convert audio data into text information. In one embodiment, server uses a neural network-based automatic speech recognition model that takes mel-spectrograms as input and outputs character or sub-word sequences using a combination of convolutional layers and transformer layers. Server trains the speech recognition module with a connectionist temporal classification loss or a sequence-to-sequence loss across a corpus of labeled speech data. Server uses a language conversion parameter from the structured instruction information to determine whether to invoke a translation module. Server uses a neural machine translation model that includes an encoder-decoder transformer architecture trained with parallel text corpora and cross-entropy loss. Server uses a speech synthesis module to generate enhanced speech when translation or summarization is requested. In one embodiment, server uses a sequence-to-sequence text-to-speech model that converts text into mel-spectrograms, followed by a neural vocoder such as a generative adversarial network-based or autoregressive waveform generator. Server conditions the text-to-speech model on speaker style and speaking rate as specified by the structured instruction information.

Server aggregates outputs of the processing modules to generate enhanced audio information and auxiliary information such as captions, visual alerts, and haptic alerts. Server constructs data structures that associate each time segment of the enhanced audio with corresponding text segments and alert events. Server creates logical channels for audio data, caption data, and alert control data and multiplexes them into a composite stream with channel identifiers and timestamps. Server continuously monitors latency and transmission quality metrics by measuring packet round-trip times, loss rates, and jitter values. Server consults the structured instruction information to determine allowed latency bounds and reduces processing load or data rates when network conditions degrade. For example, server may reduce the audio bit rate, disable non-essential enhancements, or simplify caption formatting when latency exceeds the allowed threshold.

Terminal receives the multiplexed stream, demultiplexes the logical channels, and stores each channel in appropriate buffers. Terminal uses its audio output apparatus to reproduce the enhanced audio information with minimal buffering delay. Terminal uses its display to show captions and visual alerts according to style parameters specified by the visual presentation parameter, such as font size, color, background shading, and flashing behavior. Terminal uses its haptic output apparatus to generate vibration patterns characterized by intensity, duration, and pattern sequences according to the haptic presentation parameter.

User interacts with the system by selecting profiles, entering or selecting prompt sentences, and adjusting user setting information. User may define different profiles for a classroom, a public transportation environment, a conference room, or an outdoor event. User may specify preferences such as stronger emphasis on high-frequency components, lower maximum loudness, or more prominent visual alerts. User may enter prompt sentences in natural language, including the examples described above, and the terminal transmits these prompt sentences to the server.

Server maintains a storage of structured instruction information and user setting information for each user session and for each profile. Server uses these stored configurations as initial conditions when the user resumes a session or moves to a similar environment. Server thereby reduces computational overhead by reusing previously computed instruction patterns and only updating parameters when the user modifies a prompt sentence or when the acoustic context significantly changes.

In another embodiment, server executes a lighter generative AI model on the terminal itself for specific tasks, such as local adjustment of equalization or alert style, when network connectivity is limited. Terminal stores a compressed version of the generative AI model that has fewer layers or dimensions, trained by distillation from a larger model running on the server. Terminal uses this local model to interpret prompt sentences and update local structured instruction information without round-trips to the server, thereby further reducing latency.

This architecture improves computer technology in several ways. Server replaces static, hard-coded parameters with dynamically generated, structured instruction information that is computed by a generative AI model using both acoustic features and user context. Because the generative AI model outputs machine-interpretable control parameters under a constrained grammar, the system avoids arbitrary text generation and provides deterministic control over low-level digital signal processing modules. This reduces the need for manual tuning of filters and compressions by human experts and allows the system to adapt to previously unseen acoustic environments with fewer iterations, thereby improving processing accuracy and robustness.

Server reduces computation and communication load by incorporating allowed latency and noise suppression levels directly into the structured instruction information. Server can, for example, compute that in a given scenario, a reduced frame length and simplified translation output are sufficient to meet user requirements, while in another scenario, higher-quality processing is necessary. This dynamic reconfiguration at runtime results in more efficient use of graphics processing unit resources and network bandwidth, compared with conventional systems that use fixed processing pipelines regardless of conditions.

Server and terminal cooperate to maintain synchronization of audio, captions, and alerts using logical channels and timestamping. This design reduces desynchronization errors between modalities, improving the effectiveness of alerts and the comprehensibility of captions relative to audio playback. The use of multiplexed logical channels allows the system to independently adapt each channel's data rate and quality, thereby optimizing the end-to-end behavior under constrained network conditions.

The generative AI model operates under rules and training data that differ from human decision processes. The model is trained to map from high-dimensional feature descriptors and natural-language prompt sentences to structured control outputs according to a loss function that minimizes discrepancies between predicted control parameters and expert-defined targets. This learning procedure yields control strategies that may be non-intuitive or non-linear, such as subtle balance adjustments across multiple frequency bands and dynamic range parameters, which humans would find difficult to design manually in real time. By embedding these learned strategies into a reproducible system architecture, the invention provides a technical improvement in how computers manage signal processing pipelines.

In various alternative embodiments, server may employ different neural network architectures for the generative AI model, including encoder-only transformer models or recurrent neural network-based models. Server may store the structured instruction information in different data structures, such as key-value stores, relational databases, or in-memory document stores.

Server may also adjust the type and number of processing modules based on hardware capabilities; for example, server may use a simpler filter bank-based equalizer in low-resource environments and a more complex spectral masking network in higher-resource environments.

By combining a generative AI model, feature-based prompt construction, structured instruction information, and coordinated control of digital signal processing, speech recognition, translation, and multimodal output modules, server and terminal implement a system that goes beyond mere automation of human tasks. The system improves the functioning of the computer itself by enabling real-time, context-sensitive reconfiguration of internal processing pipelines, increased processing accuracy and intelligibility, reduced communication load, and more reliable synchronization of multimodal outputs, thereby achieving technical effects that cannot be realized with conventional static or manually configured audio support systems.

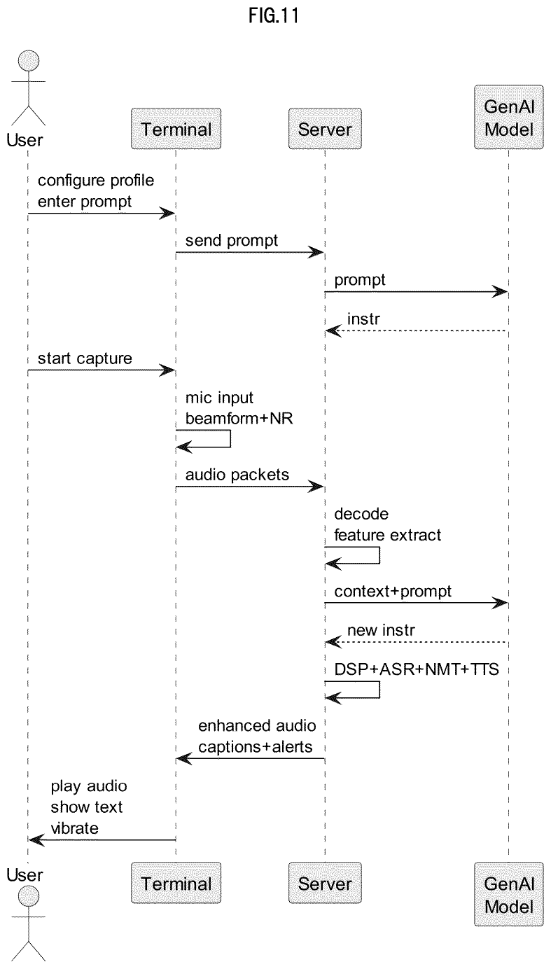

The following describes the processing flow using FIG. 11.

### Step 1:

Terminal acquires external acoustic information.

Terminal uses the microphone array as input and produces raw digital audio data as output.

Terminal converts analog sound pressure signals into digital samples using an analog-to-digital converter at a predefined sampling rate and bit depth. Terminal stores the raw audio samples in a buffer in memory. Terminal thereby transforms continuous sound waves into discrete numerical time-series data suitable for subsequent digital processing.

### Step 2:

Terminal performs spatial filtering and initial noise reduction.

Terminal takes the raw digital audio data from multiple microphones as input and outputs a beamformed, noise-reduced mono or reduced-channel signal. Terminal calculates time differences of arrival between microphone channels, computes steering coefficients toward an estimated main source direction, and linearly combines channels to emphasize the main source while attenuating off-axis noise. Terminal then applies a short-time Fourier transform to the combined signal, estimates a noise spectrum from non-speech segments, subtracts this spectrum from the current frame, and applies a spectral floor. As a result, terminal outputs a time-domain signal with reduced stationary noise compared to the input.

### Step 3:

Terminal performs frame segmentation, feature pre-computation, and encoding.

Terminal takes the noise-reduced time-domain signal as input and outputs encoded audio packets with basic metadata. Terminal divides the signal into overlapping frames of fixed duration, computes simple frame-level metrics such as energy and zero-crossing rate, and uses these metrics to drive a voice activity detector. Terminal discards or down-samples non-speech frames to reduce data volume. Terminal then uses an audio codec to compress speech frames into encoded payloads, attaches metadata including user identifier, profile identifier, and environment tag, and produces a sequence of packets prepared for transmission.

### Step 4:

Terminal transmits encoded audio and metadata to server.

Terminal takes the sequence of encoded packets and communication parameters as input and outputs a continuous network stream toward server. Terminal opens a secure streaming session over a mobile communication network and sends packets in order, each with timestamps and sequence numbers. Terminal monitors acknowledgment messages from server and may retransmit missing packets. Through this data transfer operation, terminal converts local buffered data into a remote, server-accessible stream.

### Step 5:

Server receives, decodes, and buffers incoming audio.

Server uses the network stream from terminal as input and outputs normalized linear pulse-code-modulated audio frames stored in a buffer. Server receives each packet, verifies integrity via checksums, and reorders packets based on sequence numbers. Server decodes the compressed audio payloads using a media library, resamples them to an internal standard sampling rate if necessary, and writes the resulting frames into a circular buffer. Server thereby transforms encoded, network-oriented data into a continuous, analysis-ready audio sequence.

### Step 6:

Server performs detailed feature extraction.

Server takes the normalized audio frames from the buffer as input and outputs feature vectors associated with time indices. Server applies a short-time Fourier transform to each frame to obtain magnitude and phase spectra, computes mel-spectrograms, mel-frequency cepstral coefficients, and loudness measures, and estimates pitch using an autocorrelation-based or difference-function-based algorithm. Server concatenates these measurements into numerical feature vectors and stores them in memory along with timestamps. This operation converts raw waveform data into a structured, high-dimensional representation suitable for machine learning and rule-based processing.

### Step 7:

Server constructs a context-aware prompt sentence.

Server uses the feature vectors and user attribute information as input and outputs at least one prompt sentence in natural language. Server reads current user settings, such as environment type (for example, classroom), listening purpose (for example, improve teacher intelligibility), preferred frequency bands, and target language. Server aggregates representative statistics from the feature vectors, such as background noise level, dominant frequency bands, and speech-to-noise ratio. Server then composes a natural-language sentence describing the acoustic situation and user intent, for example: “Enhance the teacher's voice in this noisy classroom by boosting consonant frequencies and suppressing background chatter while keeping latency below 150 milliseconds.” In this way, server transforms numerical feature information and configuration data into a text-based specification for the generative AI model.

### Step 8:

Server supplies the prompt sentence and contextual data to the generative AI model.

Server takes the constructed prompt sentence and, optionally, a compact representation of the feature vectors as input and outputs raw textual instructions from the generative AI model.

Server tokenizes the prompt sentence into sub-word units, encodes any additional feature descriptors into tokens or embeddings, and feeds the resulting sequence into a transformer-based generative AI model stored in memory. Server executes the model on a graphics processing unit to generate an output token sequence representing control instructions. By applying matrix multiplications and non-linear activation functions across multiple attention and feed-forward layers, server transforms the input tokens into an output text that describes desired processing parameters and behaviors.

### Step 9:

Server parses model output into structured instruction information.

Server uses the raw textual output from the generative AI model as input and produces structured instruction information as output. Server applies a predefined grammar or pattern-matching rules to the generated text to extract fields such as frequency band emphasis values, noise suppression levels, target loudness, pitch shift amount, source and target languages, visual alert style, haptic pattern, and allowed latency. Server converts the extracted values into numerical parameters and enumerations, storing them in a data structure such as a key-value map associated with a user session. This parsing and mapping step converts free-form model output into deterministic, machine-interpretable control data.

### Step 10:

Server configures digital signal processing modules based on structured instruction information.

Server takes the structured instruction information as input and outputs configured instances of digital filters and dynamic processors. Server computes filter coefficients for equalization by mapping requested gains and center frequencies to biquad or finite impulse response filter parameters. Server sets thresholds, ratios, and time constants in dynamic range controllers according to target loudness and dynamic range fields. Server configures a pitch conversion module with the specified pitch shift and formant-preservation flags. Through these computations, server translates abstract control values into concrete parameter sets that directly define the behavior of signal processing algorithms.

### Step 11:

Server applies enhancement processing to the audio signal.

Server uses the buffered audio frames and the configured processing modules as input and outputs enhanced audio frames. Server passes audio data through the equalization filters to boost or attenuate frequency bands, through the dynamic range controllers to compress or expand levels, and through pitch conversion where required. In some embodiments, server further refines the signal using a neural enhancement model that takes spectrograms as input and outputs masks or denoised spectrograms, which server converts back to waveforms.

Server thereby transforms the original, noisy waveform into an enhanced signal with improved intelligibility and user-specific characteristics.

### Step 12:

Server performs speech recognition and optional translation.

Server takes the enhanced audio frames as input and outputs text transcripts and, when requested, translated text. Server computes mel-spectrograms suitable for a speech recognition model, feeds them into an acoustic-linguistic network, and decodes the output into character or sub-word sequences. Server aligns segments of recognized text with audio timestamps. When the language conversion parameter indicates translation, server uses the speech recognition output as input to a neural machine translation model and generates translated text in a target language. This sequence of operations converts audio content into textual representations in one or more languages.

### Step 13:

Server performs optional summarization or simplification.

Server uses the recognized or translated text as input and outputs modified text according to user needs. Server may apply a text-processing model, which can be a separate generative AI component, to shorten long sentences, simplify vocabulary, or emphasize key points. Server instructs the model using a dedicated prompt sentence such as: “Simplify this technical explanation for a hearing-impaired high-school student while preserving key terms.” Server then receives simplified text aligned to the original time structure. This operation transforms the original transcript into a more accessible form for the user.

### Step 14:

Server generates auxiliary information for captions and alerts.

Server takes the recognized, translated, and optional simplified text, together with the structured instruction information, as input and outputs auxiliary information including caption segments and alert descriptors. Server segments text into caption units, assigns display start and end times based on audio timestamps, and annotates them with formatting instructions such as font size and color. Server also analyzes event classifications, such as detection of sirens or emergency announcements, and creates alert descriptors specifying visual alert style (for example, screen flashing, color changes) and haptic patterns (for example, long-short-long vibration). This step converts textual and event information into data structures tailored for multimodal presentation.

### Step 15:

Server multiplexes enhanced audio and auxiliary information into logical channels.

Server uses the enhanced audio frames, caption segments, and alert descriptors as input and outputs a multiplexed transmission stream. Server assigns separate logical channel identifiers to audio, text, and control data and attaches timestamps and sequence numbers to each payload unit. Server packs these payload units into network messages, preserving ordering within each logical channel. By combining multiple data types into a single stream while maintaining logical separation, server creates an efficient transport format that allows flexible adaptation of each modality.

### Step 16:

Server adapts transmission according to network conditions and allowed latency.

Server takes current network statistics and the allowed latency and quality parameters from the structured instruction information as input and outputs adjusted encoding settings and selective data reduction decisions. Server measures round-trip times, packet loss, and jitter, and compares these values with the allowed latency constraints. When conditions degrade, server may lower audio bit rate, reduce caption detail, or suppress non-critical alerts. Server then applies these adjustments before sending subsequent packets. This operation transforms network-state information into concrete changes in data rate and processing complexity, reducing delay and maintaining continuity of service.

### Step 17:

Terminal receives, demultiplexes, and buffers the incoming stream.

Terminal takes the multiplexed transmission stream from server as input and outputs separate audio buffers, caption buffers, and alert command queues. Terminal reads incoming packets, verifies integrity, and uses logical channel identifiers to route payloads to appropriate buffers. Terminal arranges them according to timestamps to reconstruct coherent sequences. This demultiplexing and buffering process converts the combined network stream back into modality-specific data sequences ready for presentation.

### Step 18:

Terminal decodes and outputs enhanced audio.

Terminal uses the audio buffers as input and produces sound through the audio output apparatus as output. Terminal decodes the compressed enhanced audio payloads into linear audio samples, manages an output buffer to maintain a target latency, and sends samples to the speaker or earphones via the operating system's audio subsystem. Terminal may apply final gain adjustments according to user volume settings. This step converts encoded audio data into perceptible sound tailored to the user's preferences.

### Step 19:

Terminal renders captions and visual alerts.

Terminal takes the caption buffers and visual alert descriptors as input and outputs rendered text and visual indications on the display. Terminal uses timestamp information to synchronize caption appearance with audio playback, draws text in locations, sizes, and colors specified by visual presentation parameters, and triggers flashing or color changes for alerts.

Terminal thereby transforms abstract caption and alert descriptors into concrete pixel patterns on the screen, aligned with the audio timeline.

### Step 20:

Terminal generates haptic feedback based on alert commands.

Terminal uses the haptic alert descriptors as input and outputs vibration patterns through the haptic output apparatus. Terminal translates pattern specifications, including intensity, duration, and repetition pattern, into actuator control commands via the operating system's haptic interface. Terminal starts and stops vibrations at times associated with detected events. This operation converts high-level alert descriptions into time-varying control signals for physical actuators, enabling tactile notification of important acoustic events.

### Step 21:

User configures profiles and provides prompt sentences.

User uses the terminal's user interface as input and outputs configuration changes and new prompt sentences that are stored and forwarded. User selects environment type, listening purpose, preferred frequency bands, translation language, and notification modes, and enters natural-language instructions such as “Translate the detected English speech into Japanese in real time and generate simplified speech suitable for a hearing-impaired high-school student, with large captions.” Terminal records these settings and sends the prompt sentences to server. This interaction step converts human intent and preferences into machine-readable configuration data and prompt text.

### Step 22:

Server updates structured instruction information based on new prompt sentences.

Server takes updated prompt sentences and current feature information as input and outputs revised structured instruction information. Server repeats the operations of constructing context, running the generative AI model, parsing its output, and updating parameter values for processing modules and output controllers. Server stores the new instruction sets and applies them to upcoming audio frames. This update operation transforms changes in user intent into immediate changes in computational behavior, allowing the system to adapt in real time.

### Step 23:

Server stores and reuses session-specific configurations.

Server uses the structured instruction information and user setting information at the end or during a session as input and outputs persisted configuration records. Server writes these records into a storage system indexed by user identifier and profile identifier. When a new session starts, server retrieves relevant records and initializes structured instruction information before real-time processing begins. This persistence operation transforms transient runtime states into reusable configurations, reducing future computation and stabilizing behavior across sessions.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional assistive audio systems for hearing-impaired users typically apply fixed or heuristically tuned signal processing pipelines, such as static equalization and generic noise suppression, executed locally on a device. These systems suffer from several technical limitations in terms of computer technology and networked processing architecture.

First, existing systems generally lack a mechanism for dynamically adapting their signal processing behavior to diverse acoustic environments and heterogeneous user hearing profiles in real time. Local processors with limited computational resources cannot easily execute complex models that simultaneously perform source separation, enhancement, event detection, and personalization, and therefore rely on simplified algorithms that degrade intelligibility or naturalness of the output audio.

Second, even when cloud processing is employed, known architectures often treat audio streams as undifferentiated data and do not exploit rich metadata and structured instructions to control remote processing. In particular, conventional systems do not use user-specific profiles and contextual environment information to programmatically generate explicit natural-language instructions that steer a remote generative AI model. As a result, cloud-based processing remains generic and cannot be reliably customized on a per-user, per-context basis.

Third, current networked audio enhancement systems have difficulty maintaining low latency and continuity for streaming audio while performing complex, server-side machine learning processing. Without an integrated design that coordinates local pre-processing, metadata generation, prompt-based remote processing, and multimodal output control, such systems may introduce excessive delay, create audible gaps, or fail to synchronize audio with visual and haptic cues. This impairs usability for hearing-impaired users who depend on continuous and synchronized multimodal feedback.

Fourth, prior art does not adequately integrate real-time user preference changes into the end-to-end processing pipeline. Typical systems allow only coarse configuration of volume or simple equalization, and do not propagate fine-grained user settings-such as degrees of high-frequency emphasis, background noise suppression levels, translation preferences, subtitle behavior, and notification modes for different important sounds-into the behavior of remote generative AI models. Consequently, the system cannot function as an adaptable computing platform that is reconfigured at runtime based on user interaction.

Therefore, there is a need for an improved computer-implemented system that: (i) locally analyzes captured audio to extract acoustic features and contextual metadata, (ii) transmits such metadata together with encoded audio to a remote processing apparatus, (iii) generates, on the server side, explicit prompt sentences in natural language that describe processing policies tailored to the user profile and context, (iv) applies a generative AI model controlled by the prompt sentences to produce optimized audio and related information, and (v) returns the results for synchronized audio, visual, and haptic presentation, all while supporting dynamic updates based on user settings and maintaining low-latency, continuous streaming. Such a system constitutes an improvement in computer technology in that it restructures the cooperation between terminal processing, server-side generative models, and communication protocols to realize adaptive, prompt-driven audio processing that could not previously be achieved with conventional fixed pipelines or non-prompted machine learning services.

The specific processing by the specific processing unit 290 of the data processing device 12 in Application Example 1 is realized by the following means.

The present invention provides a server comprising circuitry and memory storing instructions that, when executed, cause the server to receive, via a mobile communication network, encoded audio signals and associated additional information generated by a terminal device, the additional information including at least sound source type information, signal-to-noise ratio information, time information, and user profile information; to decode the encoded audio signals and derive audio feature values therefrom, including at least time-frequency representations suitable for machine learning processing; to generate, based on the additional information and the user profile information, a prompt sentence described in a natural language that explicitly specifies an audio processing policy, the audio processing policy including at least one of a degree of enhancement for speech components, a degree of suppression for background noise, a handling method for important sounds, and a behavior for translation or subtitle generation; to input the prompt sentence together with the audio feature values into a generative AI model implemented by a machine learning network, and to execute, by the generative AI model, at least one of audio conversion processing and audio enhancement processing in accordance with the audio processing policy so as to generate a processed audio signal optimized for the user and related information including at least one of subtitle information, visual notification information, and haptic presentation control information; and to encode and transmit, via the mobile communication network, the processed audio signal and the related information back to the terminal device for synchronized multimodal output. This enables an adaptive, prompt-driven audio processing architecture in which a remote generative AI model is programmatically controlled by explicit natural-language instructions and rich contextual metadata to perform user-specific enhancement and transformation of streaming audio with low latency, thereby improving the operation of computer-implemented audio assistance systems beyond conventional fixed or non-interactive signal processing approaches.

The term “processor” refers to hardware circuitry and/or one or more processing units, such as a central processing unit, a digital signal processor, a graphics processing unit, or a programmable logic device, configured to execute instructions to perform arithmetic operations, logical operations, control operations, and data transfer operations required to implement the described functions of the system and server.

The term “audio acquisition unit” refers to a combination of one or more transducers and associated interface circuitry that capture external sound waves and convert the sound waves into electrical signals or digital audio signals, including any microphone array, analog-to-digital converter, and driver software used to obtain audio signals from an environment.

The term “external audio signal” refers to an audio signal representing sound originating from outside the system, such as speech, environmental noise, alarms, or other acoustic events present in the physical space around a user, as captured by the audio acquisition unit.

The term “acoustic feature values” refers to numerical values that characterize properties of an audio signal in a time domain or a frequency domain, including but not limited to energy measures, spectral coefficients, mel-frequency cepstral coefficients, pitch-related features, and time-frequency distribution values, which are used for analysis, classification, or enhancement of the audio signal.

The term “hearing characteristic information” refers to information representing auditory sensitivity or auditory limitations of a user, including but not limited to audiogram data, frequency-dependent gain preferences, dynamic range preferences, and user-specific parameters for emphasizing or attenuating certain frequency components.

The term “environmental information” refers to information that describes properties of an acoustic environment or usage context in which the system operates, including but not limited to ambient noise levels, detected sound source types, time-of-day information, location category, and other contextual data used to adapt audio processing.

The term “audio enhancement processing” refers to one or more operations applied to an audio signal to improve intelligibility, clarity, or perceived quality, including but not limited to equalization, dynamic range compression, reverberation reduction, and speech-focused amplification.

The term “noise suppression processing” refers to one or more operations applied to an audio signal to reduce unwanted sound components, such as stationary or non-stationary background noise, by attenuating spectral or temporal components associated with noise while preserving desired signal components such as speech or alarms.

The term “additional information” refers to metadata generated in association with an audio signal and its acoustic feature values, including at least sound source type information, signal-to-noise ratio information, time information, user profile information, and any other metadata used by a remote apparatus or the processor to control further processing.

The term “sound source type information” refers to data indicating a classification or identification of a sound source represented in an audio signal, such as whether the source is speech, television audio, an alarm, a doorbell, environmental noise, or another relevant sound category.

The term “signal-to-noise ratio information” refers to information that quantifies a relationship between a level of desired signal components and a level of undesired noise components within an audio signal, expressed as a numerical value or range and used to control enhancement and suppression operations.

The term “time information” refers to data indicating temporal attributes of an audio signal or processed audio signal, including but not limited to timestamps, segment start times, segment end times, and timing markers used for synchronization of audio, visual, and haptic outputs.

The term “user profile information” refers to information associated with a specific user that describes at least hearing characteristics, processing preferences, language preferences, subtitle preferences, and notification preferences, and that is used to customize audio processing and presentation.

The term “encoding scheme” refers to a method or format for compressing or encoding audio signals and metadata into a form suitable for transmission or storage, including but not limited to waveform codecs, transform codecs, and packetization formats defined for digital communication.

The term “mobile communication network” refers to a wireless communication infrastructure that provides packet-based connectivity between devices and remote servers, including but not limited to cellular networks supporting high-speed data transmission and low-latency communication.

The term “external processing apparatus” refers to a computing system located remotely from a terminal device, such as a server or a cluster of servers, that receives audio signals and additional information from the terminal device and performs further processing using stored instructions and machine learning models.

The term “prompt sentence” refers to a sequence of words expressed in a natural language that describes an audio processing policy or instruction set, including parameters such as enhancement strength, noise suppression level, handling of important sounds, or translation behavior, and that is provided as input to a generative AI model to control its processing.

The term “generative AI model” refers to a trained machine learning model capable of producing output data, such as enhanced audio signals, converted audio signals, or associated information, by transforming input features and instructions, where the model may include neural networks configured for generative or transformative tasks.

The term “audio conversion processing” refers to processing that changes one or more attributes of an audio signal beyond simple enhancement, including but not limited to language conversion, voice style conversion, pitch shifting, time-scale modification, and synthesis of new audio content based on input data.

The term “processed audio signal” refers to an audio signal generated by the generative AI model or other processing modules, in which properties of an original audio signal have been modified, enhanced, or transformed in accordance with a processing policy or user requirements.

The term “related information” refers to information generated in association with a processed audio signal, including but not limited to subtitle information, visual notification information, and haptic presentation control information used to drive non-audio outputs.

The term “subtitle information” refers to textual data representing content of speech or important sounds within an audio signal, together with timing data for displaying the text in synchronization with audio playback.

The term “visual notification information” refers to display control data that specifies content, style, and timing of visual elements presented on a display device, such as text messages, icons, color changes, or graphical indications associated with detected events or processed audio.

The term “haptic presentation control information” refers to control data specifying parameters for generating haptic feedback, including but not limited to vibration patterns, durations, intensities, and sequences, used to convey information through touch.

The term “audio output for listening” refers to an audio signal prepared for acoustic presentation to a user through a loudspeaker, earphone, hearing aid, or other audio transducer, such that the user can perceive the processed sound.

The term “visual display information” refers to data that defines what is to be shown on a visual presentation device, including text, symbols, images, or graphical user interface elements, as well as their layout and timing.

The term “haptic presentation control signal” refers to a signal output from a processor to a haptic actuator, specifying a pattern or waveform for generating tactile sensations such as vibration, pulses, or other haptic effects.

The term “audio output unit” refers to hardware and associated software that convert digital audio signals into mechanical or acoustic energy for listening by a user, including loudspeakers, earphones, or hearing devices and their drivers.

The term “visual presentation unit” refers to a display device and associated control circuitry that present visual information to a user, including flat-panel displays, head-mounted displays, or other visual output devices.

The term “haptic presentation unit” refers to one or more actuators and associated control circuitry configured to produce tactile feedback, such as vibration motors, linear resonant actuators, or other haptic mechanisms.

The term “user setting information” refers to configuration data input by a user that specifies preferences or constraints for system behavior, including degrees of frequency emphasis, noise suppression levels, enablement of translation or subtitles, and notification modes for different important sounds.

The term “translation processing” refers to operations that convert linguistic content represented in an audio signal from a source language to a target language, potentially including speech recognition, language translation, and speech synthesis.

The term “subtitle display” refers to the act of presenting text corresponding to spoken content or event notifications on a visual presentation unit, generally in temporal synchronization with audio playback.

The term “important sound” refers to any sound type identified as significant for user awareness or safety, including at least siren sounds, alarm sounds, calling sounds, doorbells, intercom signals, and other alerting signals.

The term “notification mode” refers to a combination of one or more output modalities and styles used to inform a user of an important sound or event, including audio cues, visual indications, and haptic feedback patterns.

The term “directional formation processing” refers to processing that shapes the spatial response of an audio acquisition unit, such as beamforming or spatial filtering, to emphasize sounds from a particular direction while attenuating sounds from other directions.

The term “educational environment” refers to a use context that involves instructional activity, such as a classroom, lecture hall, or similar setting, in which a speaker's voice and background sounds are present.

The term “event information” refers to metadata indicating that a particular important sound or event has been detected, including the type of event, its detection time, and optionally its estimated importance or priority.

The term “real-time feedback” refers to processing and output operations performed with delay sufficiently small that a user perceives audio and corresponding visual or haptic outputs as occurring without noticeable lag relative to the original events.

The term “display style of the subtitles” refers to visual attributes of subtitle presentation, including font type, font size, color, background, position on the screen, and display duration.

The term “form of visual notification” refers to a manner in which visual indications are presented to a user, such as pop-up messages, icons, flashing elements, color changes, or overlay windows.

The term “pattern and intensity of haptic presentation” refers to temporal and amplitude characteristics of tactile feedback, including sequences of vibrations, intervals between pulses, and strength of the tactile stimulus.

The term “low-latency and high-speed bidirectional communication” refers to a communication mode in which data can be exchanged between a terminal device and an external processing apparatus in both directions with short transmission delays and at a data rate sufficient to support continuous streaming and control signaling.

The term “streaming audio” refers to audio data transmitted in a continuous or near-continuous sequence of packets such that playback can begin before all packets have been received, enabling ongoing real-time or quasi-real-time presentation to a user.

In an embodiment, a terminal and a server cooperate to implement an adaptive audio assistance system for a hearing-impaired user. The terminal includes at least one microphone, an audio codec, a local processor, a memory, a communication interface for a mobile communication network, an audio output device, a display device, and a haptic actuator. The server includes at least one processor, at least one memory, a network interface, and one or more hardware accelerators such as graphics processing units. The terminal and the server are connected via a mobile communication network that supports high-speed and low-latency packet transmission.

The terminal generates a digital audio signal by converting sound from the physical environment into sampled data. The terminal uses a microphone array, for example a plurality of micro-electro-mechanical microphones, connected to an audio codec that performs analog-to-digital conversion at a predetermined sampling rate such as 16 kHz or 48 kHz and a predetermined bit depth such as 16 bits. The terminal stores the sampled data in a circular buffer in a main memory and provides the samples to a local processor implemented as a general-purpose central processing unit or as a system-on-chip including a digital signal processor.

The terminal performs signal analysis and feature extraction using concrete algorithms. The terminal divides the audio samples into overlapping frames of a fixed length and applies a window function such as a Hamming window. The terminal computes a discrete Fourier transform for each frame to obtain complex spectral coefficients. From these coefficients, the terminal calculates acoustic feature values such as power spectra, mel-frequency cepstral coefficients, spectral centroid, spectral flux, and zero-crossing rate. The terminal stores these acoustic feature values in a structured data record together with time indices, where each record corresponds to a particular frame or group of frames. By using this structure, the terminal can efficiently pass compact feature sets to downstream classifiers and reduce raw data volume.

The terminal uses the extracted acoustic feature values to perform sound type classification.

The terminal may use a lightweight neural network with a small number of layers, for example a feed-forward network with two or three hidden layers, or a shallow convolutional network, taking as input a feature vector composed of mel-frequency cepstral coefficients and energy values. The network outputs likelihoods for different classes such as “speech”, “television audio”, “doorbell”, “alarm”, and “environmental noise”. The terminal selects the class with highest likelihood as the sound source type information for the corresponding time segment. This classification result is stored in the additional information structure along with the acoustic feature values and the time information.

The terminal also accesses hearing characteristic information for the user. The terminal stores in a memory a user profile including an audiogram or simplified parameters such as preferred gain per frequency band, dynamic range compression ratios, and maximum comfortable levels. The terminal reads these parameters and computes a frequency-dependent gain curve.

The terminal applies this gain curve to the spectral coefficients by multiplying each coefficient in a given frequency band by a pre-computed gain factor. This processing occurs on the local processor or on a digital signal processor core to reduce the dynamic range that must be handled by the server and to provide an initial personalization prior to remote processing.

The terminal generates additional information as a structured metadata object. In one embodiment, the terminal constructs a data record that includes at least the following fields: sound source type information as a categorical value, signal-to-noise ratio information as a floating-point numerical value, time information as an absolute or relative timestamp, user profile identifiers that link to stored hearing characteristic information, and flags that indicate whether the current context is educational, residential, emergency, or another environment type. The terminal periodically updates this additional information and transmits it together with encoded audio to the server, thereby reducing the need for the server to recompute basic context and enabling more efficient and targeted processing.

The terminal uses an audio codec to compress the audio signal before transmission. The terminal may implement a perceptual audio encoder, such as a transform-based encoder that computes a modified discrete cosine transform and applies psychoacoustic masking models to reduce bit rate. The terminal adjusts the bit rate based on measured channel conditions obtained from the mobile communication interface. By lowering the bit rate in poor conditions and increasing it when the network allows, the terminal reduces packet loss and latency, achieving a technical improvement in overall streaming stability and continuity.

The server receives the compressed audio signal and the additional information via a network interface. The server uses a software stack such as a web server and an application server to terminate transport layer connections, reassemble packets, and pass data to processing modules. The server decodes the compressed audio using a decoder corresponding to the encoder used by the terminal and reconstructs linear pulse-code modulation samples. The server stores the reconstructed samples in a buffer and associates them with the received additional information so that each audio segment has corresponding metadata entries.

The server computes higher-level feature representations tailored for a generative AI model.

The server applies a short-time Fourier transform to the linear pulse-code modulation samples using a frame size and hop size aligned with the model configuration. The server computes mel-spectrograms by projecting the magnitude spectra onto a mel filter bank and then applying a logarithmic operation. The server normalizes these features using mean and variance statistics collected from training data. The server stacks a fixed number of frames into a two-dimensional tensor to form a model input segment. This explicit transformation from waveform to mel-spectrogram and the use of normalized tensors enable stable and efficient operation of the generative AI model.

The server constructs a prompt sentence for each segment or context based on the additional information. The server uses procedural logic, not a human operator, to generate the prompt sentence. For example, when the additional information indicates that the sound source type information corresponds to speech and that the signal-to-noise ratio is low in an educational environment, the server generates a prompt sentence such as:

“Enhance the teacher's speech for an elderly listener by emphasizing high-frequency components, strongly suppressing background classroom noise and media playback, and preserving natural timbre without introducing metallic artifacts.”

When the additional information indicates a detected doorbell or alarm, the server generates a prompt sentence such as:

“Detect and emphasize doorbell and alarm sounds, reduce all other environmental sounds to a low level, and produce clearly perceivable beeps and vibration control signals for the user.” When the user profile indicates that translation is enabled, the server generates a prompt sentence such as:

“Translate the caregiver's speech from the source language to the target language, maintain moderate speaking speed and clear articulation suitable for an elderly listener, and generate synchronized subtitles and audio in the target language.”

The server may use different rule sets to generate prompt sentences according to combinations of sound source type information, user profile information, and time-of-day information, resulting in technical control signals that parametrize the generative AI model without changing the underlying model weights.

The server inputs both the prompt sentence and the audio feature tensor into the generative AI model. In one embodiment, the server uses a transformer-based architecture that includes an encoder for audio features, an encoder for text features, and a decoder or generator that produces an enhanced or converted spectrogram. The server tokenizes the prompt sentence using a predetermined vocabulary and converts the tokens into numerical indices. These indices are embedded into a sequence of vectors through a learned embedding matrix. The server then processes the embedded text sequence through multiple layers of self-attention and feed-forward networks to obtain a text context representation.

The server processes the audio feature tensor through an audio encoder made of convolutional or transformer layers. The audio encoder applies attention across time and frequency to capture dependencies, producing an audio context representation. The server combines the text context and the audio context in a cross-attention module where attention weights determine, for each audio time-frequency position, which parts of the text instruction are most relevant. The resulting combined representation is fed into a generator network that predicts an enhanced or converted mel-spectrogram or directly predicts waveform samples using an autoregressive or flow-based decoder. This concrete architecture, including tokenization, embeddings, self-attention, and cross-attention, establishes a specific technical pipeline that leverages generative AI to implement fine-grained, instruction-controlled signal transformation.

The server trains the generative AI model prior to deployment using a large number of paired examples that include noisy or unprocessed audio features, clean or target audio features, contextual metadata, and prompt sentences generated by rules or templates. The server uses a supervised learning procedure with an error function that includes at least a mean squared error between predicted and reference spectrograms, a perceptual loss based on a pre-trained audio encoder, and optionally an adversarial loss when a discriminator network is used. The server updates model parameters by backpropagation and a gradient-based optimizer such as an adaptive moment estimation method. The server augments training data by adding synthetic noises, applying reverberation filters, and altering pitch and speed so that the model can generalize to varied real-world conditions. This detailed training procedure ensures that the model learns to respond to modifications in the prompt sentence with predictable changes in spectral shaping and noise suppression behavior, thereby improving the controllability and stability of the system compared to conventional black-box models.

The server uses the above architecture and training to achieve improved performance in terms of intelligibility and latency. Because the prompt sentence encodes processing intent at a high level while the model encodes acoustic patterns at a low level, the server can reuse a single trained model for multiple tasks such as enhancement, translation-based conversion, and event-specific highlighting, avoiding the need for separate models and reducing computation and memory consumption. The combination of metadata and prompt-driven control allows the server to skip unnecessary computation in segments where only light enhancement is required, thereby reducing inference time and power consumption on the server hardware.

The server generates related information in addition to the processed audio signal. In one embodiment, the server uses an auxiliary speech recognition module to decode the processed audio signal into text. The server aligns recognized text segments with time information from the processed audio signal to produce subtitle information. The server formats the subtitle information as a sequence of entries that each contain a display start time, a display end time, and a text string. The server also generates visual notification information and haptic presentation control information based on event information within the additional information. For example, when a doorbell is detected, the server may set a visual notification type to a particular icon and set a haptic pattern parameter to a predefined vibration sequence. These data structures are sent back to the terminal along with the processed audio signal.

The terminal receives the processed audio signal and the related information via the mobile communication network. The terminal decodes the audio using a decoder corresponding to the encoder used on the server and outputs the signal to the audio output unit. The terminal also interprets the subtitle information and visual notification information to render text and graphical elements on the display device. The terminal uses the haptic presentation control information to control the haptic actuator to generate vibration patterns according to parameters such as duration, interval, and intensity. The synchronization between the audio output and the subtitles is achieved by using the time information included in the processed audio signal and the subtitle information. By performing this synchronized multimodal output, the terminal provides consistent cues to the user even in noisy situations.

The terminal and the server jointly reduce end-to-end latency through several technical mechanisms. The terminal performs preliminary enhancement and data compression so that less data must be transmitted and the server can focus on higher-level, prompt-driven transformations. The server uses streaming inference where input features are processed in overlapping segments and output segments are sent in a pipelined manner. The use of efficient data structures for audio features and prompt tokens, along with computational optimizations such as mixed-precision arithmetic on graphics processing units, reduces inference time for each segment. As a result, the user experiences minimal delay between real-world sound events and the enhanced outputs.

The user configures the system through a graphical user interface on the terminal. The user can specify degrees of high-frequency emphasis, levels of background noise suppression, enablement of translation, and styles of subtitles and notifications. The terminal sends this user setting information to the server as structured configuration messages. The server uses these settings to select among different prompt sentence templates and to set scalar parameters within the prompt sentences, such as “strongly suppress background noise” or “slightly enhance high-frequency components.” This dynamic parameterization allows the same generative AI model to adapt its behavior per user and per context without retraining, which improves flexibility and reduces server load.

The described system goes beyond mere automation of human manual processing. A human listener could not replicate the exact sequence of digital transforms, feature extraction, neural attention operations, and low-latency streaming coordination performed by the terminal and the server. The use of prompt sentences and generative AI models is not used simply to reproduce human judgment but rather to implement non-intuitive combinations of spectral filtering, temporal smoothing, and event detection learned from large datasets. This produces a concrete improvement in computer technology by integrating metadata-aware, instruction-controlled generative processing with communication protocols and output device control to achieve higher intelligibility, lower error rates in event detection, reduced communication overhead, and improved latency characteristics compared to conventional fixed pipelines.

In an alternative embodiment, the server may employ a different neural architecture, such as a recurrent neural network with attention or a convolutional sequence model, instead of a transformer. The core concept remains that the model receives both audio feature tensors and an encoded representation of a prompt sentence and that the model's internal layers use this prompt representation to modulate filter weights or attention distributions. In another variation, the terminal may execute a smaller generative AI model locally when network conditions are poor, using a reduced version of the same architecture with fewer layers and parameters, while the server continues to perform full-scale processing when connectivity allows. These variations demonstrate that the inventive concept is not limited to a specific hardware platform or particular algorithm, but rather to a structured cooperation between a terminal and a server, prompt-driven generative processing, and synchronized multimodal output.

By specifying concrete data structures for audio features and metadata, precise neural architectures for the generative AI model, explicit training methods, and dedicated control flows for prompt sentence generation and multimodal output, the described embodiments provide sufficient detail for a skilled person to implement the invention. Furthermore, the integration of these elements yields a measurable technical benefit in terms of improved speech intelligibility, more accurate detection of important sounds, reduced latency, and efficient utilization of network and computational resources.

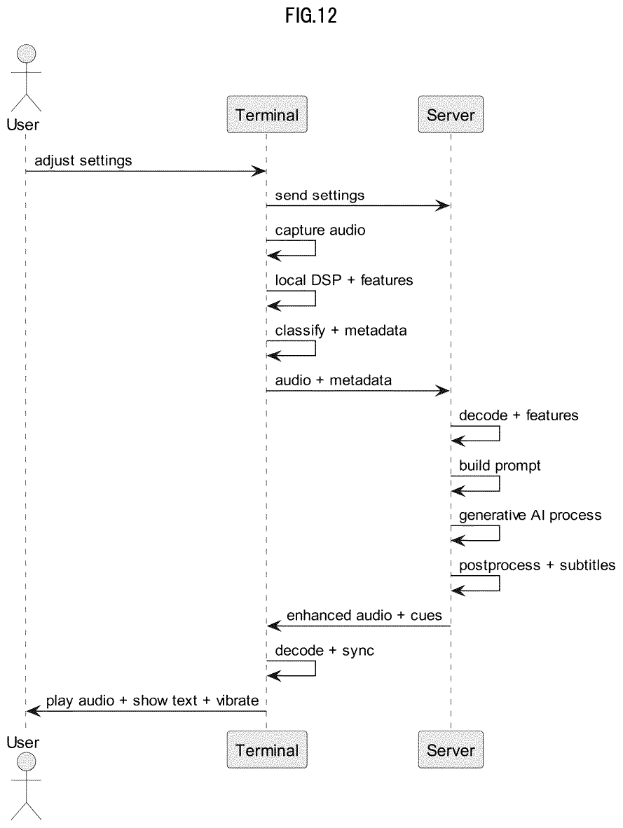

The following describes the processing flow using FIG. 12.

### Step 1:

The terminal captures external sound and generates raw audio data.

The terminal uses a microphone array and an audio codec as input devices to receive analog sound waves from the environment. The terminal converts the analog signals into digital samples at a predetermined sampling rate and bit depth, and outputs digitized audio frames stored in a buffer. Based on this input, the terminal performs windowing and segmentation operations to divide the continuous stream into fixed-length frames, each with an associated timestamp, thereby generating a structured sequence of audio frames suitable for further processing.

### Step 2:

The terminal analyzes audio frames and extracts acoustic feature values.

The terminal takes as input the audio frames and their timestamps from Step 1 and outputs acoustic feature vectors for each frame. The terminal applies a Fourier transform to each frame to obtain complex spectra, then computes magnitude spectra, mel-frequency cepstral coefficients, spectral centroid, and energy values. Using these operations, the terminal transforms time-domain waveform data into multi-dimensional numerical feature vectors that compactly represent spectral and temporal characteristics of the sound.

### Step 3:

The terminal classifies sound source types and estimates signal-to-noise ratio.

The terminal uses as input the acoustic feature vectors from Step 2 and outputs sound source type information and signal-to-noise ratio information for each time segment. The terminal feeds the feature vectors into a lightweight classifier, such as a small neural network, which computes class probabilities for categories including speech, television audio, doorbell, alarm, and environmental noise. The terminal selects the most probable class as the sound source type and calculates signal-to-noise ratio by comparing estimated speech energy to noise energy across frequency bands. The terminal thus converts raw features into semantic labels and quantitative noise measures.

### Step 4:

The terminal applies user-specific frequency shaping based on hearing characteristics.

The terminal receives as input the audio frames and their spectra from Step 2 and user hearing characteristic information stored in a local profile. The terminal outputs modified spectra and corresponding time-domain frames adapted to the user. The terminal calculates a gain curve over frequency bands from the hearing characteristic information, then multiplies each spectral component by a gain factor in the corresponding band. The terminal performs inverse Fourier transforms to reconstruct time-domain frames with emphasized or attenuated frequency regions, thereby creating personalized audio data aligned with the user's hearing profile.

### Step 5:

The terminal generates additional information and prepares metadata.

The terminal uses as input the sound source type information, signal-to-noise ratio information, timestamps, and user profile identifiers obtained in previous steps. The terminal outputs a structured additional information record for each audio segment. The terminal constructs a data object that includes at least sound source type, signal-to-noise ratio, time information, environment flags, and user profile references. The terminal aggregates these fields into a compact metadata structure that is indexed by segment time, thereby enabling the server to interpret context without re-computing local analyses.

### Step 6:

The terminal encodes personalized audio and transmits data over a mobile communication network.

The terminal takes as input the user-adapted audio frames from Step 4 and the additional information records from Step 5 and outputs compressed bitstreams and metadata packets sent to the server. The terminal applies an audio encoding scheme to the frames, such as transform-based compression, to reduce bit rate. The terminal then packetizes the encoded audio together with associated metadata into transmission units and sends them through the mobile communication interface to the server. The terminal thereby transforms high-volume waveform data and metadata into network-efficient packets suitable for low-latency streaming.

### Step 7:

The server receives and decodes compressed audio and associates metadata.

The server uses as input the compressed audio bitstreams and additional information packets sent by the terminal, and outputs decoded linear audio data synchronized with metadata. The server reassembles packets, verifies integrity, and decodes the compressed audio into linear pulse-code modulation samples. The server maps each decoded audio segment to its corresponding additional information record using timestamps. This processing converts network packets into a coherent sequence of audio segments and context descriptors for further analysis.

### Step 8:

The server computes model-ready audio feature tensors.

The server takes as input the decoded audio segments and time information from Step 7 and outputs normalized audio feature tensors for the generative AI model. The server applies a short-time Fourier transform to each segment, computes mel-spectrograms, and then normalizes these features using pre-computed statistical parameters. The server stacks a fixed number of mel-spectrogram frames into two-dimensional tensors with time and frequency axes. Through these transformations, the server converts raw audio into standardized numerical arrays that satisfy the input requirements of the generative AI model.

### Step 9:

The server generates a prompt sentence describing an audio processing policy.

The server uses as input the additional information including sound source type, signal-to-noise ratio, environment flags, and user profile information, and outputs a prompt sentence in natural language. The server executes rule-based logic to select templates and parameter values that reflect the user's preferences and the current context. For example, the server may generate prompt sentences such as:

“Enhance the caregiver's speech for an elderly listener by emphasizing high-frequency components and strongly suppressing background television and environmental noise while preserving natural voice quality.”
or

“Detect and emphasize doorbell and alarm sounds, reduce all other sounds to a low level, and generate information for clear visual and haptic alerts.” Based on the input metadata, the server assembles text that encodes a concrete audio processing policy, transforming numeric context into an explicit instruction.

### Step 10:

The server encodes the prompt sentence and prepares joint inputs for the generative AI model. The server uses as input the prompt sentence from Step 9 and the audio feature tensors from Step 8, and outputs tokenized text sequences and aligned feature tensors for model inference. The server tokenizes the prompt sentence into discrete symbols of a predefined vocabulary and converts them into integer token IDs. The server then embeds these token IDs into vectors through a learned embedding matrix and arranges them as a sequence. The server passes the embedded prompt sequence and the audio feature tensor into the model's respective encoders, thereby transforming textual and acoustic information into compatible internal representations.

### Step 11:

The server performs generative audio transformation using a neural architecture.

The server takes as input the embedded prompt sequence and the audio feature tensor from Step 10 and outputs an enhanced or converted representation of the audio. The server processes the prompt sequence through layers of self-attention and feed-forward networks to obtain a text context representation, and processes the audio features through an audio encoder to obtain an audio context representation. The server applies cross-attention mechanisms where each audio position computes attention weights over the text tokens, thus modulating audio processing according to the prompt sentence. The server then runs a generator network that predicts an enhanced mel-spectrogram or waveform samples based on the combined representation. The output is a processed audio representation that reflects both acoustic patterns and the policy encoded in the prompt sentence.

### Step 12:

The server reconstructs a time-domain processed audio signal and generates related information.

The server uses as input the enhanced or converted audio representation from Step 11 and, optionally, the original decoded audio. The server outputs a processed audio signal in the time domain and auxiliary related information such as subtitles and notification parameters. The server applies inverse transforms, such as inverse short-time Fourier transform, to convert spectrograms back to waveforms. The server normalizes loudness and may apply a limiter to prevent clipping. The server optionally performs speech recognition on the processed audio to derive subtitle text and aligns it with time indices. The server generates visual notification information and haptic presentation control information based on detected important sounds. Through these operations, the server transforms internal model outputs into concrete audio and control data for terminal devices.

### Step 13:

The server encodes processed audio and packages multimodal output data for transmission.

The server takes as input the processed audio waveform and the related information from Step 12 and outputs encoded audio bitstreams and associated control data packets. The server compresses the processed audio using an audio encoder suitable for low-latency streaming and attaches subtitle entries, visual notification parameters, and haptic control parameters as structured metadata. The server groups these elements into packets according to a streaming protocol and transmits them over the mobile communication network to the terminal. This step converts high-resolution processed audio and multimodal control information into network-efficient data structures.

### Step 14:

The terminal receives processed audio and control data and prepares synchronized outputs.

The terminal uses as input the encoded processed audio bitstreams and multimodal metadata sent by the server, and outputs decoded audio samples, formatted subtitle items, and device-specific control commands. The terminal decodes the processed audio and stores the samples in a playback buffer. The terminal parses subtitle information to create display entries with start and end times and parses notification and haptic parameters to map them to local display and actuator commands. By aligning the time information in these inputs, the terminal prepares to drive multiple output devices in a synchronized manner.

### Step 15:

The terminal presents audio, visual, and haptic outputs to the user.

The terminal takes as input the decoded audio samples, subtitle entries, visual notification parameters, and haptic control commands from Step 14 and outputs physical signals from the audio output unit, the display device, and the haptic actuator. The terminal sends the processed audio samples to a digital-to-analog converter and amplifier connected to speakers or earphones, producing sound tailored to the user. Simultaneously, the terminal renders subtitles and visual notifications on the display at times specified by the subtitle entries and notification parameters. The terminal drives the haptic actuator to generate vibration patterns when important events occur. Using the time alignment, the terminal ensures that audio, visual, and haptic outputs are synchronized, thereby converting digital data and control information into coordinated real-world stimuli perceived by the user.

### Step 16:

The user adjusts settings and influences subsequent processing behavior.

The user receives as input the multimodal outputs from Step 15 and provides configuration input through a graphical user interface on the terminal, such as slider adjustments for high-frequency emphasis, toggles for noise suppression strength, and options for translation and subtitle behavior. The terminal collects this user setting information and outputs updated configuration data to the server. Based on this input, the server modifies prompt sentence templates and parameter values used in Step 9, and the terminal updates local frequency shaping parameters used in Step 4. This feedback loop converts user interaction into concrete numerical and textual control signals that alter the generative AI model's behavior and local processing, enabling continuous adaptation of the system.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional audio assistance systems for hearing-impaired users or users in noisy environments typically apply uniform signal processing such as fixed noise reduction, static gain control, or preset frequency equalization. These systems are often implemented as fixed-function digital signal processing pipelines that do not adapt to a current affective state of a user, a current usage scene, or a fine-grained user preference profile. As a result, such systems exhibit several technical limitations.

First, existing architectures usually couple front-end acquisition and back-end enhancement in a rigid manner: a terminal device captures audio, applies basic noise suppression, and forwards audio frames to a remote processor, which then performs generic enhancement or transcription. The pipeline does not exploit contextual signals such as user speech patterns or real-time emotion-related features extracted from user utterances. Consequently, processing parameters such as speaking rate, local gain around important words, and notification modality are selected using static heuristics or coarse per-application settings rather than fine-grained, per-user, per-situation optimization. This leads to suboptimal intelligibility of speech, especially when a user is confused, anxious, or fatigued.

Second, although generative AI models can in principle generate rich control signals (e.g., dynamic audio processing parameters, structured summaries, or notification policies), conventional systems either do not integrate such models into the real-time audio pipeline, or they use such models only to generate human-readable text (e.g., captions) without turning their outputs into machine-readable control parameters for low-level audio and notification subsystems. In particular, conventional systems lack a structured interface layer that translates user state, profile data, and scene information into well-formed prompt sentences that instruct a generative AI model to output both text and formalized audio-processing parameters suitable for direct application by digital signal processing modules. This omission prevents the generative AI model from being used as a dynamic controller for time-scale modification, segment-wise gain control, and multimodal notification orchestration.

Third, conventional server-terminal architectures do not close the loop between user-side reactions and server-side control policy. Many systems do not incorporate emotion estimation from user speech, or they treat such estimation merely as auxiliary metadata for analytics, rather than as a real-time signal that drives adaptation of the audio and notification pipeline. Without a mechanism to estimate emotion states from user speech features, correlate such states with stored user profiles, and synthesize them into prompts for a generative AI model, the system cannot adjust speaking rate, emphasis, or notification modality in a continuous, context-aware manner.

Fourth, known systems are often limited to a single modality of output (typically audio or text captions) and offer only coarse control over visual or haptic notifications. For instance, a siren may simply trigger a fixed vibration pattern or a static visual icon, regardless of whether a user is anxious or calm, and regardless of user-specific preferences regarding vibration strength or visual salience. In a public space or emergency context, this lack of adaptive multimodal control can cause either over-stimulation (e.g., excessively loud alarms for anxious users) or under-notification (e.g., inaudible alerts for users with reduced hearing). From a computer-technology perspective, these limitations result from the absence of an integrated computational framework that (i) acquires and preprocesses external audio and user speech; (ii) extracts emotion-relevant acoustic features from user speech; (iii) stores and retrieves a multi-parameter user profile including listening and notification preferences; (iv) computes a context-dependent control policy; (v) synthesizes a structured, natural-language prompt sentence to drive a generative AI model; and (vi) converts the model's outputs into concrete audio-processing parameters and multimodal notification control information that are applied by low-level digital signal processing and device-control components. Thus, there is a need for a technical framework that improves the operation of computers and networks by enabling a server-side processor to dynamically configure an audio and notification pipeline based on emotion estimation, user profile data, and generative AI model outputs, thereby improving intelligibility, reducing cognitive load, and achieving more efficient and adaptive use of computational resources across server and terminal devices.

The specific processing by the specific processing unit 290 of the data processing device 12 in Example 2 is realized by the following means.

The present invention provides a server comprising at least one processor and at least one memory storing instructions executable by the at least one processor, the at least one processor being configured to cooperate with a terminal device to acquire external audio via an acoustic input unit of the terminal device and user speech separately from the external audio, to generate audio feature data from the user speech, to perform signal processing including noise reduction processing and directivity control processing on the external audio so as to generate preprocessed audio data, to estimate an emotional state of a user based on the audio feature data, to store and retrieve a user profile for the user including listening conditions and notification conditions, to generate, based on the estimated emotional state, the user profile, and usage-scene information, a prompt sentence in a natural language that specifies processing contents, output formats, and constraint conditions for a generative AI model, to input the prompt sentence and at least one of the preprocessed audio data and text data obtained from the preprocessed audio data into the generative AI model and obtain from the generative AI model audio processing parameters, visual-presentation text information, and notification control information, to execute, based on the audio processing parameters, audio conversion processing including speaking-rate adjustment processing, volume adjustment processing, and frequency-characteristic adjustment processing to generate converted audio data, and to generate control commands for causing the terminal device to output, based on the visual-presentation text information and the notification control information, at least one of audio output, visual output, and haptic output in a manner adapted to the emotional state and the user profile. This enables the server and terminal device, as a distributed computer system, to improve technical performance of audio assistance and notification processing by dynamically configuring low-level digital signal processing and multimodal output control in response to automatically estimated user emotion and stored user preferences, by using a generative AI model as a controllable intermediary that outputs structured audio-processing parameters and notification-control information, thereby enhancing speech intelligibility and reducing user cognitive load in real time while efficiently utilizing computational and communication resources.

The term “external audio” refers to any sound present in an environment, including human speech, alarm sounds, announcement sounds, and other acoustic signals, that is acquired by an acoustic input unit and is not generated as intentional user speech directed to the system.

The term “user speech” refers to speech uttered by a user toward a terminal device, including questions, responses, and spontaneous remarks, and acquired separately from external audio for use in feature extraction and emotion estimation.

The term “acoustic input unit” refers to a hardware component or combination of hardware components, such as one or more microphones or a microphone array, and associated circuitry, configured to convert ambient sound into electrical signals for subsequent digitization.

The term “audio feature data” refers to numerical data derived from user speech, including but not limited to pitch, energy, speech rate, silence duration, and spectral characteristics, which is used as input for emotion estimation or other analysis.

The term “signal processing” refers to digital or analog operations applied to audio signals, including noise reduction, directivity control, filtering, time-frequency transformation, and related algorithms that modify or analyze the signals.

The term “noise reduction processing” refers to operations that attenuate or remove undesired components of an audio signal, such as environmental noise or background sounds, by techniques including spectral subtraction, filtering, or statistical estimation.

The term “directivity control processing” refers to operations that enhance sound from a desired direction and suppress sound from other directions, for example by beamforming or spatial filtering on signals acquired from multiple microphones.

The term “preprocessed audio data” refers to digital audio data obtained after applying signal processing, including at least noise reduction processing and directivity control processing, to external audio, and which serves as an input for subsequent recognition or conversion.

The term “emotional state” refers to information indicating a psychological condition of a user, such as confusion, anxiety, fatigue, focus, calmness, or other affective categories, optionally associated with an intensity value.

The term “user profile” refers to a set of data associated with a particular user, including listening conditions such as preferred volume and sensitive frequency bands, and notification conditions such as preferred visual and haptic notification characteristics.

The term “listening conditions” refers to configuration parameters that describe how audio should be processed and presented to a user, including preferred volume level, frequency emphasis, speaking rate, and other audio-related preferences.

The term “notification conditions” refers to configuration parameters that describe how notifications should be delivered to a user, including use, intensity, timing, and pattern of visual and haptic outputs, and optional constraints on audio output.

The term “usage-scene information” refers to information indicating a current context or environment in which the system is used, such as an educational scene, a public-space scene, or a conference scene, and which affects control policies.

The term “prompt sentence” refers to a natural-language text that specifies processing contents, output formats, and constraint conditions to be given to a generative AI model, and that is constructed based on an emotional state, a user profile, and usage-scene information.

The term “generative AI model” refers to a machine learning model trained on large-scale data that, in response to text or other input, generates structured outputs including text, control parameters, or metadata, and which can be controlled by prompt sentences.

The term “audio processing parameters” refers to numerical or symbolic values that define how audio is to be modified, including speaking-rate factors, gain values, and frequency-characteristic adjustment parameters for specific time segments or the entire signal.

The term “visual-presentation text information” refers to text data intended to be displayed to a user, including subtitles, summaries, translations, or other textual representations of audio content.

The term “notification control information” refers to parameters specifying how to perform multimodal notification, including indications of whether to use audio, visual, and haptic outputs, and associated attributes such as level, duration, color, timing, and pattern.

The term “speaking-rate adjustment processing” refers to audio processing that changes the temporal speed of spoken content, such as slowing down or speeding up speech, while preferably preserving pitch characteristics.

The term “volume adjustment processing” refers to audio processing that modifies the amplitude of an audio signal, either globally or locally in specific time segments, in order to increase or decrease loudness.

The term “frequency-characteristic adjustment processing” refers to audio processing that modifies the spectral distribution of an audio signal, such as emphasizing or attenuating specified frequency bands to enhance intelligibility or match user preferences.

The term “converted audio data” refers to audio data generated after application of one or more audio processing parameters to preprocessed audio data, including speaking-rate, volume, and frequency-characteristic adjustments.

The term “acoustic output unit” refers to a hardware component that converts digital or analog audio signals into sound waves perceivable by a user, such as a speaker, earphone, or headphone.

The term “visual output unit” refers to a hardware component configured to present visual information to a user, such as a display device, indicator light, or graphical user interface element.

The term “haptic output unit” refers to a hardware component configured to provide tactile feedback to a user, such as a vibration actuator or other device capable of generating controlled mechanical stimulation.

The term “terminal device” refers to an information processing apparatus operated by a user, including but not limited to a mobile terminal, tablet, wearable device, or similar device, which includes at least an acoustic input unit and one or more output units.

The term “server” refers to an information processing apparatus or distributed computing resource, including at least one processor and at least one memory, configured to perform centralized processing such as emotion estimation, prompt generation, generative AI execution, and audio conversion.

The term “time-stretching parameters” refers to numerical values or functions used to control time-scale modification of audio, defining how the duration of specific segments or entire utterances is to be increased or decreased.

The term “gain control parameters” refers to numerical values or functions that specify gain factors to be applied to audio signals, including segment-wise gain adjustments for enhancing or attenuating selected portions of speech.

The term “simplified text information” refers to text that succinctly describes essential content of audio events, such as alarm sounds or emergency announcements, in a shorter and less complex form than the original content.

The term “public-space scene” refers to a usage scene in which external audio is acquired in a shared environment such as a station, airport, or similar facility, and in which alarms, announcements, or other public signals may be present.

In one or more embodiments, a system includes a terminal and a server that cooperate to provide emotion-adaptive audio assistance and multimodal notification. The system is implemented by specific hardware and software components and is arranged so that the server and the terminal execute coordinated digital signal processing, emotion estimation, prompt generation, generative AI model inference, and device control. The system uses these computational elements not merely to automate human judgment, but to improve the technical operation of audio pipelines, notification subsystems, and networked computer resources.

### A. Overall Hardware and Software Configuration

The terminal is an information processing device such as a mobile terminal, a tablet, or a wearable device. The terminal includes at least one microphone or a microphone array, an analog-to-digital converter, a processor, a memory, a communication interface, an audio output device, a visual output device, and a haptic output device.

The terminal executes an operating system for mobile devices and application software including an audio acquisition application, a feature extraction module, and a presentation control application. The terminal uses an audio input API provided by the operating system, such as an API equivalent to AudioRecord or an input node of an audio engine framework, to obtain raw audio signals from the microphone hardware.

The server is an information processing device or a group of devices including at least one central processing unit, at least one memory, a non-volatile storage device, and a network interface. The server executes a server operating system and runs one or more server applications, including an audio processing application, an emotion engine, a prompt generation module, a generative AI orchestration module, an audio conversion module, and an output control module. The server optionally uses hardware accelerators such as graphics processing units to execute neural networks used for emotion estimation and generative AI inference.

The server uses a data management subsystem such as a relational database to store user profiles including listening conditions and notification conditions. The server may further use an in-memory data store to cache recent audio segments, feature vectors, and emotion state data.

### B. Acquisition and Preprocessing of External Audio and User Speech

The terminal acquires external audio through the microphone array. The terminal converts analog signals into digital PCM samples using the analog-to-digital converter at a sampling rate such as 16 kHz or 48 kHz, with a bit depth such as 16 bits, and stores the samples in buffers in memory. The terminal distinguishes external audio and user speech either by microphone grouping (for example, front-facing microphones for external audio, near-field microphone for user speech) or by beam direction derived from a beamforming configuration.

The terminal applies beamforming to the external audio using a digital signal processing library (for example, a library implementing delay-and-sum or filter-and-sum beamforming).

The terminal computes channel-specific delays based on an assumed direction of arrival and applies sample shifts and weighting coefficients to the multichannel PCM data. The terminal then sums the delayed channels to generate an enhanced monaural or reduced-channel signal oriented toward a target direction.

The terminal applies noise reduction by converting time-domain frames to the frequency domain using a fast Fourier transform function from a mathematical library. The terminal estimates noise spectral power from low-energy intervals and subtracts or attenuates it using spectral subtraction or band-pass filtering. As a result, the terminal generates preprocessed audio that has improved signal-to-noise ratio for the target speaker. This preprocessing reduces the computational burden on the server and improves the accuracy of later speech recognition and generative AI processing.

The terminal also acquires user speech directed toward the device. The terminal segments this speech into frames and applies feature extraction using a library for speech analysis (for example, a library analogous to openSMILE or librosa). The terminal computes pitch by an autocorrelation-based method or a fundamental frequency estimation algorithm; calculates frame-wise energy (e.g., root-mean-square amplitude); detects voiced and unvoiced frames by voice activity detection; and calculates derived metrics such as speech rate (number of voiced frames per second) and average silence durations. The terminal encodes these quantities as audio feature data, which are transmitted to the server as structured numerical arrays or as serialized data structures.

By executing these operations locally, the terminal offloads part of the computational work from the server and reduces the data volume sent over the network. The use of beamforming and frequency-domain noise reduction results in more compact, informative input for later processing and directly improves the technical performance of the overall system, including reduced error rates in emotion estimation and generative AI outputs.

### C. Emotion Estimation and User Profile Utilization on the Server

The server receives the preprocessed audio and the audio feature data from the terminal through a secure network protocol such as HTTPS. The server decodes any compressed audio data (for example, audio encoded with a general-purpose codec) into PCM format using a media processing library. The server stores both audio and feature data in memory structures indexed by user identifier and timestamps.

The server executes an emotion engine implemented using a deep learning framework. In one embodiment, the server uses a recurrent neural network or a transformer-based network to estimate emotional state from audio features. The server constructs an input tensor from a sequence of feature vectors extracted over a fixed-length time window (for example, the last 10-30 seconds). The server normalizes each feature dimension by precomputed means and variances, which enhances numerical stability and convergence.

The server feeds this tensor through multiple layers of the model. In a transformer variant, the server applies linear transformations to obtain query, key, and value representations, performs self-attention to capture temporal dependencies, applies non-linear activation functions such as rectified linear units, and finally applies a softmax layer that outputs probabilities over defined emotion categories such as confusion, anxiety, fatigue, focus, and calmness. During training of the model, the server or an offline training system uses a labeled dataset of speech with emotion annotations, defines a cross-entropy loss function over the emotion labels, and updates network weights by gradient descent or a related optimization method. The training system can apply data augmentation such as adding background noise or time stretching to improve robustness.

The server stores the resulting emotion state as a data structure containing an emotion label, a probability score, and a timestamp. The server compares the current state with previous states to detect significant transitions. By performing this processing, the server transforms raw audio feature sequences into a compact, discriminative representation of emotional state that drives downstream decisions. This use of a specific neural architecture and feature pipeline improves emotion classification accuracy relative to simple rule-based thresholding and enables the system to respond more precisely to changes in the user's affective condition.

The server accesses a user profile stored in a relational database. The profile includes parameters such as preferred volume range, frequency bands that are difficult to perceive, preferred maximum subtitle length, and preferred intensity and pattern of haptic feedback.

The server retrieves the profile based on user identifier, constructs a control policy that considers the emotion state, the profile, and the usage scene, and stores this control policy as a structured object containing target speaking-rate factors, segment emphasis settings, and notification modality preferences.

The server may update the user profile based on explicit user feedback or implicit behavioral signals. When the user indicates that audio is too fast or notifications are too strong, the server stores this feedback and modifies profile parameters accordingly in the database. This feedback loop results in progressive adaptation of the system to the user's characteristics and contributes to improved long-term performance and reduced need for manual adjustment.

### D. Prompt Generation and Generative AI Model Execution

The server generates a prompt sentence for a generative AI model based on the emotion state, the user profile, and the usage scene. The server uses a prompt-generation module that implements a rule-based or template-based algorithm. The module selects a template according to scene type (for example, educational scene, public-space scene, or conference scene) and emotion label (for example, confusion or anxiety). The module fills parameter slots with concrete numeric values from the control policy, such as target speaking rate and gain values.

The server generates the prompt sentence as a structured natural-language instruction that describes not only the role of the generative AI model but also the required output format and constraints. By constructing the prompt explicitly in this way, the server shapes the generative AI outputs into machine-readable control parameters as well as human-readable text. This differs from naive use of language models where outputs are unstructured prose and not directly usable by low-level signal processing modules.

In an educational scene where the user is confused, the server may generate a prompt sentence such as:

“You are a generative AI model specialized in speech processing and summarization.

The user is currently confused and cannot easily understand the teacher's explanation. You will receive:
(a) the teacher's utterance text with segment timing, and
(b) a user profile indicating that the user prefers slower speech and short subtitles in Japanese.

Perform the following tasks and return the result as JSON:
1) Compute time-stretch parameters to reduce the effective speaking rate to about 70% of normal, preserving pitch.
2) Identify important technical terms and keywords, and for each associated segment, output a gain adjustment value (in dB) to locally increase volume by around 3 dB.
3) Generate a concise Japanese subtitle summary covering the key points, limited to at most three lines of text.

Return JSON with fields: time_scale_params, gain_params, and subtitle text.” In a public-space scene where the user is anxious, the server may generate a prompt sentence such as:

“You are a generative AI model specialized in audio event detection and notification design.

The user is currently on a train platform and is in an anxious state.

The input audio may contain train-approach sirens and emergency announcements.

Perform the following:
1) Detect segments containing siren sounds and emergency announcements, and output their start and end times.
2) Convert the content of the siren and announcement into concise Japanese text within two lines so that the user will not be overly startled.
3) Generate control metadata recommending a notification pattern that avoids very loud audio and instead uses large on-screen text and icons with three gentle vibration pulses.” The server then passes the prompt sentence together with context text (for example, transcribed audio) to the generative AI model. The model is, for example, a transformer-based language model trained on large corpora of text to minimize a next-token prediction loss. The server configures model inference parameters such as temperature and maximum output length to encourage deterministic, structured outputs.

The server uses an inference library to tokenize the prompt and context, embed tokens into continuous vectors, apply multiple transformer layers with self-attention, and decode output tokens. The server then parses the generated text into structured objects containing audio processing parameters (time-stretch factors, segment-wise gain values, equalization instructions), display text information (subtitles, summaries, translations), and notification control information (indicating modes, intensities, and timing for visual and haptic outputs). By transforming high-dimensional model outputs into low-level control parameters through carefully designed prompt sentences and parsing logic, the server uses the generative AI model as a controller for technical subsystems, rather than as a generic text generator. This architecture produces a non-conventional interaction between a language model and an audio processing pipeline, yielding technical improvements: for instance, it enables dynamic, context-aware adjustment of speech rate and emphasis that would be difficult to implement with static rule sets.

### E. Audio Conversion and Multimodal Device Control

The server applies the audio processing parameters to the preprocessed audio using an audio conversion module. The server uses an audio processing library or custom DSP algorithms to perform time-scale modification by a method such as waveform similarity overlap-add or phase vocoder. The server chooses algorithm parameters such as window size and overlap ratio based on the time-stretch factors obtained from the generative AI model. By using parameter values specific to each audio segment, the server can slow down or speed up only the parts of the speech that require adjustment, improving comprehension while reducing computational cost compared to uniformly processing the entire stream.

The server applies segment-wise gain control by multiplying sample values by scalar gain factors for intervals that include important technical terms or warnings. This enhances the salience of key segments without increasing the global volume, thereby reducing the risk of discomfort or distortion.

The server optionally applies frequency-characteristic adjustment such as equalization filters configured according to user profile data. For example, if the user has difficulty hearing high frequencies, the server boosts energy in that band by configuring filter coefficients for an equalizer. This adjustment is computed numerically and implemented as finite impulse response or infinite impulse response filters.

The server then produces converted audio data and encodes it using an efficient codec for transmission to the terminal. By performing time-scale modification and equalization at the server, the system centralizes computationally intensive operations and can share model-based control logic across multiple terminals.

The server also generates output control information from the notification control information. The server encodes parameters such as flash color, flash frequency, vibration strength, and vibration pattern in a way that is directly interpretable by the terminal's presentation control application. The server transmits these control commands along with the converted audio and display text information to the terminal.

The terminal receives the converted audio and decodes it to PCM samples using a decoder library. The terminal drives the audio output device by writing the PCM samples to an audio output buffer through an audio output API. The terminal displays the visual presentation text information, such as subtitles or summaries, in synchronization with audio playback, using a graphical user interface framework to render text with appropriate font size and position. The terminal activates the haptic output device according to the notification control information by calling a vibration or haptic feedback API with specified intensities and timing.

In this way, the system controls real-world devices—speakers, displays, and vibration actuators—based on computed parameters determined through a structured generative AI pipeline. This coupling between AI-driven parameter generation and device-level control goes beyond mere information display and directly adjusts hardware behavior, providing a concrete technological application that satisfies statutory requirements.

### F. Technical Effects and Improvements to Computer Technology

The server improves computational efficiency by delegating front-end beamforming and feature extraction to the terminal, which reduces the amount of data transmitted and the computational load on the server. The preprocessed audio has a higher signal-to-noise ratio, which leads to more accurate emotion estimation and generative AI outputs, reducing the need for repeated or corrective processing.

The server improves the accuracy of emotion estimation by using a specialized neural network architecture and well-defined acoustic feature vectors. Unlike simple human labeling or manual interpretation of speech rate and tone, the server executes quantitative analysis over large time windows, which reduces subjective variability and increases consistency of classification.

The system improves the efficiency and adaptability of audio processing by using prompt sentences and generative AI outputs to compute control parameters. Instead of static hard-coded rules or manual user settings, the system dynamically adjusts parameters based on emotional state, profile, and scene. This approach reduces manual configuration effort and enables fine-grained segment-level control that would be difficult for human operators to manage in real time.

The system also improves communication efficiency by transmitting compact parameters rather than continuously streaming high-bandwidth raw audio when only control needs to change. For example, the server can update time-stretch and gain parameters in response to a new emotion state without retransmitting the original audio, and the terminal can reuse stored audio segments with new parameters when appropriate in some variants.

Moreover, the neural network for emotion estimation and the generative AI model are not used as black boxes that replace manual choices; instead, they are integrated into a pipeline that uses their outputs to drive specific technical subsystems. The decision rules encoded in prompt templates and parsing logic represent a non-conventional use of language models as controllers that output machine-readable DSP parameters. The resulting system architecture improves speech intelligibility, reduces user cognitive load, and allows stable operation in noisy and dynamic environments.

### G. Variations and Additional Embodiments

The server may use different neural architectures for emotion estimation, such as convolutional neural networks operating on spectrograms or hybrid models combining recurrent layers and attention mechanisms. The server may update model parameters over time through online or federated learning, using anonymized user data and a loss function that combines emotion classification accuracy with downstream performance metrics such as user feedback scores.

The generative AI model may be hosted locally on the server or accessed via a remote inference service. The prompt content can be adapted to other languages or to domain-specific vocabularies, and the output formats can be extended to include additional control information such as dynamic equalization curves or spatial audio parameters.

The terminal may implement portions of the emotion estimation or generative AI inference when local computational resources are sufficient, with the server providing fallback or more complex processing. The architecture thus supports load balancing and fault tolerance.

The server may also aggregate anonymized emotion and performance data across users to optimize prompt templates and control policies. For example, the server can analyze which combinations of speaking rate and gain adjustment provide the highest comprehension scores in particular scenes, and then adjust templates accordingly.

In all these embodiments, the terminal, the server, and the user interact through specific hardware and software, with defined data structures, algorithms, and control flows. The system thus provides a concrete technical implementation that enables a generative AI model and a prompt sentence mechanism to improve audio processing pipelines, device control, and user experience in real-world environments.

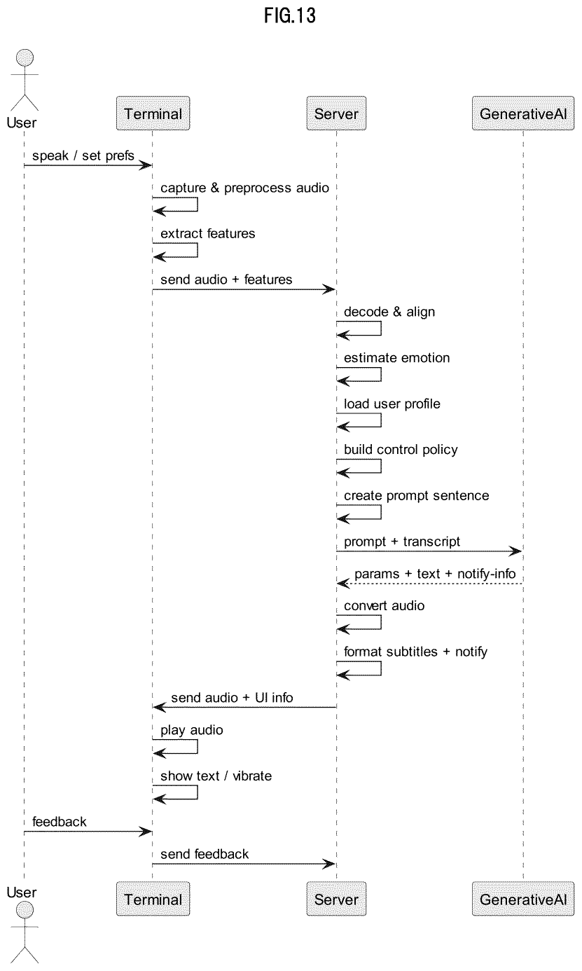

The following describes the processing flow using FIG. 13.

### Step 1:

The terminal acquires raw audio signals for external audio and user speech.

The terminal uses its microphone or microphone array to convert ambient sound into analog electrical signals and routes these signals through an audio input path of the operating system. The terminal uses an analog-to-digital converter to sample the analog signals at a predefined sampling rate (for example, 16 kHz or 48 kHz) and quantization bit depth (for example, 16 bits), thereby generating digital PCM frames. The input to this step is the analog acoustic signal present around the user, including environmental sounds and user utterances. The terminal segments the continuous PCM stream into short, fixed-length frames (for example, 10-20 milliseconds) and classifies frames as external audio or user speech based on microphone selection or beam direction. The output of this step is two digital data streams: a PCM frame sequence for external audio and a PCM frame sequence for user speech, both stored in circular buffers in the terminal memory.

### Step 2:

The terminal performs beamforming and noise reduction on the external audio.

The terminal reads a block of multichannel PCM frames corresponding to the external audio from its buffer. The input to this step is multichannel PCM data representing external sound.

The terminal uses a digital signal processing library to calculate per-channel delays based on a target direction of arrival (for example, toward a teacher or an announcement speaker). The terminal shifts each channel by the corresponding delay and multiplies by weighting coefficients, then sums all channels to produce a single enhanced audio channel; this operation constitutes delay-and-sum beamforming. Next, the terminal applies a fast Fourier transform to each frame to obtain a complex spectrum, estimates noise power from low-energy segments, and subtracts or suppresses noise power in each frequency bin by spectral subtraction or frequency-domain filtering. The terminal then applies an inverse fast Fourier transform to reconstruct time-domain frames with reduced noise. The output of this step is preprocessed external audio data: a monaural or reduced-channel PCM stream with improved signal-to-noise ratio, stored as preprocessed frames in a dedicated buffer.

### Step 3:

The terminal extracts acoustic features from user speech for emotion estimation.

The terminal reads a sequence of PCM frames corresponding to user speech from the user speech buffer. The input to this step is single-channel PCM data of user-directed utterances.

The terminal applies a pre-emphasis filter to each frame, multiplies by a window function such as a Hamming window, and passes the frame to a feature extraction library. The terminal computes frame-level features such as fundamental frequency using an autocorrelation-based algorithm, energy using root-mean-square amplitude, and zero-crossing rate. The terminal runs a voice activity detection algorithm that compares energy and spectral characteristics to thresholds to label frames as voiced or unvoiced. The terminal aggregates statistics across frames to calculate speech rate (for example, voiced frames per second) and average silence duration (for example, number of consecutive unvoiced frames). The terminal combines these values into feature vectors with associated timestamps and scene tags. The output of this step is audio feature data, which represents the user's speech characteristics in a structured numeric form and is stored in a transmission queue.

### Step 4:

The terminal compresses the preprocessed external audio and serializes the audio feature data. The terminal collects a sequence of preprocessed external audio frames covering a defined time interval, for example one second. The input to this step is the preprocessed external audio PCM stream and the audio feature data from the previous step. The terminal uses an audio codec implementation to encode the PCM frames into compressed audio packets using a variable bitrate scheme; during encoding, the terminal calls codec functions that perform linear prediction, transform coding, and entropy coding to reduce data size. The terminal serializes the feature vectors into a structured representation, such as a JSON document listing time stamps and feature values. The terminal then constructs a network payload that bundles the compressed audio packets and serialized feature data into an HTTP or HTTPS request body. The output of this step is a network message containing compressed audio data and corresponding emotion-related feature data, which is transmitted to the server via the communication interface.

### Step 5:

The server receives and decodes the audio and feature data.

The server listens for incoming requests on a network port and uses a web application framework to parse the received payload. The input to this step is the network message containing compressed external audio and serialized audio feature data. The server separates the compressed audio stream from the feature data and forwards the audio to a media decoding library that reconstructs PCM frames by reversing the codec's transform, prediction, and entropy-coding steps. Simultaneously, the server deserializes the feature data into in-memory objects or records. The server associates decoded PCM audio segments with corresponding sequences of feature vectors by aligning their timestamps. The output of this step is a set of synchronized data: decoded preprocessed audio PCM frames and structured audio feature sequences, stored in server memory and indexed by user and time.

### Step 6:

The server estimates the emotional state of the user based on the audio feature data.

The server selects a sliding window of feature vectors for a recent time interval, for example the last 10 to 30 seconds, from the stored feature sequences. The input to this step is a sequence of feature vectors representing pitch, energy, speech rate, silence metrics, and possibly spectral descriptors, along with their timestamps. The server normalizes each feature dimension using stored mean and standard deviation values and arranges the normalized vectors into an input tensor of shape (sequence length×feature dimension). The server feeds this tensor to an emotion classification model implemented with a neural network architecture such as a recurrent neural network or a transformer. The neural network consists of layers that compute matrix multiplications, bias additions, non-linear activations, attention weights, and a final softmax layer over predefined emotion categories. The server executes the forward pass to obtain a probability distribution over emotion labels like confusion, anxiety, fatigue, and calmness. The server selects the label with the maximum probability and reads its probability as an intensity score. The output of this step is emotion state data, which includes an emotion label, a confidence score, and a timestamp, stored as a record for use in policy and prompt generation.

### Step 7:

The server retrieves the user profile and computes a control policy.

The server uses the user identifier carried in the request or a session token to query a relational database. The input to this step is the user identifier, the emotion state data, and context information including the usage scene (for example, classroom or public space). The server retrieves a set of profile fields describing listening conditions such as preferred volume range and difficult frequency bands, and notification conditions such as visual and haptic preferences. The server then uses a rule-based or heuristic algorithm to combine the emotion label, scene, and profile values into a control policy. For example, if the label is confusion in a classroom scene, the server determines a target speaking rate factor (for example, 0.7), a gain boost for segments containing important terms (for example, +3 dB), and a maximum subtitle length (for example, three lines). The server represents this control policy as a structured object containing numerical parameters and mode flags. The output of this step is the control policy object that will parameterize the prompt sentence and later processing.

### Step 8:

The server generates a prompt sentence for the generative AI model based on the control policy.

The server passes the control policy, the emotion state data, and scene information to a prompt generation module. The input to this step is the structured control policy and context data. The server selects a template corresponding to the scene and emotion; for example, a “teaching support” template for a classroom with confusion or an “alert moderation” template for a public space with anxiety. The server substitutes specific numeric values and preferences from the control policy into the template slots, such as a numeric speed factor, a gain boost magnitude, and subtitle length constraint. The server constructs a complete prompt sentence that describes the role of the generative AI model, the user's condition, the required processing steps, and the desired output format for parameters and text. The output of this step is a natural-language prompt sentence that unambiguously instructs the generative AI model to produce audio processing parameters, visual text, and notification control metadata suited to the user's current state.

### Step 9:

The server executes the generative AI model using the prompt sentence and text derived from the audio.

The server obtains or generates textual content for the external audio, for example by passing the preprocessed audio through a speech recognition engine to obtain a transcript with segment timing. The input to this step is the prompt sentence and the context text such as the transcript. The server uses a generative AI client library to tokenize the prompt and transcript, encode them into embeddings, and feed them into a transformer-based language model that has been trained to predict sequences of tokens. The server configures inference parameters such as temperature, top-k or top-p sampling thresholds, and maximum token length to bias the model toward deterministic, structured responses. The generative AI model produces an output sequence of tokens which the library decodes into text. The server then parses this text to extract structured elements such as time-stretch parameters per segment, gain adjustments, equalization hints, subtitle text, and notification control directives. The output of this step is a set of machine-readable data structures: audio processing parameters, visual-presentation text information, and notification control information generated in alignment with the prompt instructions.

### Step 10:

The server applies the audio processing parameters to convert the preprocessed audio.

The server combines the decoded preprocessed audio PCM frames from Step 5 and the audio processing parameters from Step 9. The input to this step is preprocessed audio data and structured parameters specifying time-scale factors, gain values, and optional frequency adjustments for specific time segments. The server uses an audio processing library to segment the audio according to the timing information used by the generative AI model. For each segment, the server applies time-scale modification using a method such as waveform similarity overlap-add or a phase vocoder; these algorithms resample or re-synthesize the segment in the time domain using overlapping windows and phase-consistent reconstruction.

The server computes new sample values so that the speech rate is reduced or increased according to the specified factor while preserving pitch. The server then multiplies segment samples by gain factors to emphasize or attenuate selected intervals and applies digital filters if frequency emphasis has been requested. The output of this step is converted audio data, a PCM stream in which speaking rate, volume, and spectral balance have been adapted to the control policy and generative AI output.

### Step 11:

The server formats the visual-presentation text information and notification control information for the terminal.

The server takes the subtitle or summary text returned by the generative AI model and divides it into display units aligned with audio playback times. The input to this step is visual-presentation text information, notification control information, and timing metadata from the parameters. The server determines time ranges for each line of text based on the original transcript alignment and any changes in duration introduced by time-scale modification, and constructs subtitle records containing text and start-end timestamps. The server maps the notification directives into a concise representation for the terminal, such as keys and numeric values for flash behavior, icon display, and vibration patterns. The output of this step is a package consisting of converted audio (optionally re-encoded with a codec), subtitle timing and text records, and notification control metadata, prepared for network transmission to the terminal.

### Step 12:

The terminal receives the converted audio and control information and presents multimodal output to the user.

The terminal receives the network response from the server via the communication interface. The input to this step is the response package containing converted audio data, subtitle or summary text with timestamps, and notification control metadata. The terminal decodes the audio to PCM frames if the server encoded it with a codec and configures an audio playback stream using an audio output API. The terminal schedules frames to be written to the output buffer at appropriate times, thereby generating audible speech at the adjusted rate and volume. Simultaneously, the terminal uses a graphical user interface framework to render subtitle lines on the display at times indicated by the timestamps and removes or replaces them when their display intervals end. The terminal interprets the notification control metadata and calls visual and haptic output APIs to flash the screen, highlight icons, or trigger vibrations with specified intensity and pattern. The output of this step is the physical presentation of adapted speech, textual information, and tactile alerts to the user through the terminal's audio, visual, and haptic devices.

### Step 13:

The user perceives the output and may provide feedback that affects future control policies. The user listens to the converted audio, reads subtitles or summaries, and experiences any haptic notifications produced by the terminal. The input to this step is the multimodal output generated in Step 12. The user evaluates whether the speech is understandable, whether the pace is comfortable, and whether notifications are appropriate in strength and modality, and may indicate satisfaction or dissatisfaction through the terminal's user interface, for example by pressing buttons labeled “too fast,” “too loud,” or “too strong vibration.” The terminal collects these feedback signals as structured data entries and transmits them to the server, where they can be used to adjust listening and notification preferences in the user profile. The output of this step is updated preference data that will inform subsequent runs of Steps 7 and 8, resulting in refined control policies and improved personalization over time.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional assistive audio systems that rely on simple amplification, fixed noise reduction, or static audio rendering have significant limitations from the perspective of computer technology. First, such systems typically operate on a single input modality, for example, only on acoustic signals, without fusing heterogeneous data sources such as facial images and environmental state information. As a result, the underlying processing pipeline cannot adapt its internal parameters or output strategy to the dynamic psychological and environmental context of the user, which leads to sub-optimal and sometimes counter-productive output (e.g., uniformly louder and faster speech in a situation where the user is anxious or fatigued).

Second, existing systems usually implement fixed-rule digital signal processing chains, in which beamforming, gain correction, noise suppression, and speech presentation settings are specified by static algorithms or hand-tuned parameters. These systems lack a programmatic mechanism for conditionally controlling advanced generative AI models through machine-generated prompt sentences. In particular, the computing architecture does not provide a way for the processor to derive, from multimodal features and user state, precise prompt sentences that instruct a generative AI model how to transform content (e.g., which speech segments to emphasize, how to adjust speech rate, and how to simplify linguistic content) in a manner tailored to the user's current emotional state and hearing characteristics. Consequently, the computational pipeline cannot fully leverage large generative models to improve the clarity, relevance, and cognitive accessibility of audio information.

Third, many assistive audio solutions focus only on improving the acoustic output and do not provide an integrated, low-latency, multi-modal output architecture that combines auditory, visual, and tactile channels in a coordinated fashion. From a systems engineering viewpoint, there is no end-to-end framework in which a processor: (i) estimates a user's emotional state from multimodal features via a learned model; (ii) automatically constructs prompt sentences for a generative AI model; (iii) obtains converted audio data and converted character data; and (iv) maps these into synchronized multi-modal outputs whose timing, intensity, and formatting are adaptively controlled based on emotional state metadata. This absence of a coherent, processor-implemented control loop limits the ability of the computer system itself to optimize resource usage, latency, and user-specific rendering policies.

Fourth, conventional architectures do not define how to structure data flows and processing steps so that a single processor (or a coordinated set of processing resources) can consistently: (a) perform spatial signal processing, frequency-domain hearing compensation, and noise suppression; (b) perform multimodal emotion inference; and (c) orchestrate generative AI calls and multi-modal rendering, all under explicit, programmable control. Without such an integrated architecture, improvements are usually local (e.g., marginally better noise reduction) rather than systemic. The computer system remains a loose collection of components rather than an adaptive, prompt-driven generative audio information platform. Accordingly, there is a need for a computer-implemented system and processing architecture in which the processor dynamically controls digital signal processing, multimodal emotion estimation, prompt-based control of a generative AI model, and multi-modal output rendering, such that audio information can be transformed and presented in real time according to the user's emotional state, hearing characteristics, and environmental context. The technical problem addressed by the present invention is to improve the functioning of such a computer system itself—namely, to provide a processor-implemented pipeline that (i) fuses multimodal inputs, (ii) generates context-adaptive prompt sentences for a generative AI model, and (iii) delivers optimized multi-modal output with reduced computational waste and improved robustness, so that important audio information is reliably and efficiently conveyed to users with hearing or cognitive difficulties.

The specific processing by the specific processing unit 290 of the data processing device 12 in Application Example 2 is realized by the following means.

The present invention provides a server comprising a processor and a memory storing instructions that, when executed by the processor, cause the server to acquire external sound through an acoustic conversion unit and generate multi-channel audio signals, to perform spatial signal processing on the multi-channel audio signals to emphasize a sound component from a predetermined direction and to output a direction-emphasized audio signal, to perform frequency analysis on the direction-emphasized audio signal, to refer to user-specific hearing characteristic information stored in the memory, and to execute gain correction for respective frequency bands and noise suppression so as to generate a preprocessed audio signal adapted to a user's hearing characteristics, to estimate an emotional state of the user by inputting at least one of the preprocessed audio signal, a facial image of the user, an audio feature of the user, and environmental state information into a learned multimodal inference model and by calculating probability values for a plurality of emotion categories, to generate, based on the estimated emotional state and on at least one of the preprocessed audio signal and character information generated from the preprocessed audio signal, instruction information that constructs a prompt sentence to be input to a generative AI model, to control the generative AI model by transmitting the prompt sentence and at least one of the preprocessed audio signal and the character information to the generative AI model so as to cause the generative AI model to execute a conversion process or a generation process for audio information including at least one of enhancement of speech, conversion of speech rate, simplification of content, and suppression of background sound in accordance with the emotional state and the environmental state information, and to thereby generate converted audio data or converted character data, and to output the converted audio data as auditory stimulation and to output the converted character data as at least one of visual information and tactile information in a plurality of modalities under control of the processor using emotional state metadata. This enables the computer system to operate as an integrated, prompt-driven generative audio platform that adaptively controls digital signal processing, multimodal emotion recognition, generative AI inference, and multi-modal output rendering, thereby improving the technical performance of the system in terms of real-time responsiveness, robustness to environmental noise, efficient use of computational resources, and accuracy and accessibility of audio information delivery for users with hearing or cognitive impairments.

The term “acoustic conversion unit” refers to a hardware and software combination including at least one sound transducer and associated circuitry that converts external acoustic waves into digital or analog electrical audio signals suitable for processing by a processor.

The term “multi-channel audio signals” refers to a set of two or more audio signal streams acquired from different spatial positions or transducers, which are temporally aligned and represent sound captured from multiple directions.

The term “spatial signal processing” refers to a class of digital signal processing operations applied to multi-channel audio signals, including beamforming and related algorithms, that exploit spatial diversity of microphones to emphasize or attenuate sound components arriving from specified directions.

The term “direction-emphasized audio signal” refers to a single-channel or reduced-channel audio signal resulting from spatial signal processing, in which sound components from a predetermined direction are enhanced relative to sound components from other directions.

The term “hearing characteristic information” refers to user-specific data stored in a memory that indicates the auditory sensitivity or hearing loss profile of a user across different frequency bands, sound pressure levels, or other acoustic parameters.

The term “gain correction for respective frequency bands” refers to a digital signal processing operation in which amplitude scaling factors are applied per frequency band or frequency bin to an audio spectrum so as to adjust the relative strength of different frequency components based on hearing characteristic information.

The term “noise suppression” refers to a digital signal processing operation that estimates noise components in an audio signal and attenuates or removes those components, for example using spectral subtraction, adaptive filtering, or similar algorithms, to improve the signal-to-noise ratio.

The term “preprocessed audio signal” refers to an audio signal that has been subjected to at least one of spatial signal processing, frequency-domain gain correction, and noise suppression, and that is adapted for subsequent feature extraction, emotion estimation, or generative processing.

The term “emotional state” refers to information indicating a psychological or affective condition of a user, such as calm, anxiety, confusion, fatigue, or depression, which is estimated by processing multimodal input signals.

The term “facial image” refers to a digital image or image region that includes at least a portion of a user's face and that is suitable for extracting visual features related to facial expressions.

The term “audio feature” refers to a numerical representation of properties of an audio signal, such as pitch, energy, spectral coefficients, or temporal statistics, that can be used as input to a machine learning model.

The term “environmental state information” refers to data indicating contextual conditions surrounding a user, including but not limited to ambient noise level, time zone or time of day, and illumination state.

The term “learned multimodal inference model” refers to a machine learning model, such as a neural network, that has been trained using data from multiple modalities, including audio features, facial images, and environmental information, to infer an emotional state or other target variables.

The term “probability values for a plurality of emotion categories” refers to numerical values output by a learned model that represent the likelihoods or relative confidences associated with different emotional states.

The term “character information” refers to digital text data generated from an audio signal by a speech-to-text process or by a generative model, and that represents linguistic content for further processing or presentation.

The term “prompt sentence” refers to a natural-language or quasi-natural-language instruction or query that is provided as input to a generative AI model to specify desired processing behavior, constraints, output format, or transformation goals.

The term “instruction information that constructs a prompt sentence” refers to structured data or parameters generated by a processor that specify content, conditions, and formatting rules used to assemble a prompt sentence for input to a generative AI model.

The term “generative AI model” refers to an artificial intelligence model, such as a large language model or a generative audio model, that is capable of generating or transforming content, including at least text or audio, based on input data and prompt sentences.

The term “conversion process or generation process for audio information” refers to a computational operation performed by a generative AI model in which input audio or text data is transformed, enhanced, summarized, reformatted, or newly generated according to constraints specified by a prompt sentence.

The term “enhancement of speech” refers to processing that increases the clarity, intelligibility, or prominence of speech components in audio data relative to background sounds or less important content.

The term “conversion of speech rate” refers to processing that modifies the temporal characteristics of speech, including slowing down or speeding up spoken content without substantially altering pitch in a way that degrades intelligibility.

The term “simplification of content” refers to processing that modifies linguistic content to reduce complexity, including shortening sentences, reducing vocabulary difficulty, or reordering information to make it easier to understand.

The term “suppression of background sound” refers to processing that reduces or removes non-target sounds, such as environmental noise or overlapping sources, to make a target sound, such as a caregiver's speech, more prominent.

The term “converted audio data” refers to audio data output by a processing pipeline or generative AI model after execution of at least one of speech enhancement, speech rate conversion, content-based transformation, or background sound suppression.

The term “converted character data” refers to text data output by a processing pipeline or generative AI model after execution of at least one of content simplification, segmentation, rephrasing, or other text transformation in accordance with a prompt sentence.

The term “auditory stimulation” refers to information presented to a user through sound using an acoustic output device, such as a loudspeaker or earphone.

The term “visual information” refers to information presented to a user through a display device, such as text, symbols, or graphics, that can include subtitles or other on-screen indications.

The term “tactile information” refers to information presented to a user through a haptic output device, such as vibration or pressure patterns, that can convey alerts or cues via touch.

The term “plurality of modalities” refers to two or more distinct sensory channels used to present information to a user, such as auditory, visual, and tactile channels.

The term “emotional state metadata” refers to additional data associated with audio and text outputs that describes the estimated emotional state of the user and that is used to control presentation parameters such as volume, display timing, and vibration intensity.

The term “audio codec” refers to a software or hardware component that encodes audio data into a compressed format and decodes compressed audio data back into an uncompressed format.

The term “acoustic output device” refers to a device such as a loudspeaker, headphone, or earphone that converts electrical audio signals into sound waves perceivable by a user.

The term “display device” refers to an electronic visual display, such as a monitor, screen, or panel, capable of presenting text, images, or graphics to a user.

The term “tactile output device” refers to a hardware component, such as a vibration actuator, that generates tactile sensations on a user's body to convey information.

The term “notification type” refers to classification data indicating the kind or priority of an event or message, such as an alarm, reminder, or informational notice, that influences how output is presented to the user.

The term “sound volume” refers to a parameter controlling the amplitude of an audio signal delivered to an acoustic output device, typically perceived as loudness by a user.

The term “display timing” refers to temporal parameters that define when and for how long visual information, such as subtitles, is presented on a display device.

The term “vibration intensity” refers to a parameter that specifies the strength or magnitude of tactile output generated by a tactile output device.

The term “multi-channel audio signals to emphasize a sound component from a predetermined direction” refers to an operation in which a processor uses spatial relationships among multiple audio channels to increase the relative level of a target sound coming from a known or estimated direction compared to other directions.

The term “user-specific hearing characteristic information stored in the memory” refers to individualized audiological data associated with a particular user and retained in digital storage for use in adaptive audio processing.

In the following embodiments, a server, a terminal, and a user cooperate to implement the claimed system. The same reference architecture can be realized on different hardware platforms and operating systems as long as equivalent functional modules are provided.

### A. Overall System Architecture

A terminal is located in a user's living space or care facility. The terminal includes at least one acoustic conversion unit, a camera, one or more general-purpose processors, local memory, a wireless communication interface, and multi-modal output devices such as a speaker, a display, and a vibration actuator. The terminal runs an operating system such as a general-purpose mobile operating system or a general-purpose desktop operating system, and audio, video, and networking middleware such as ALSA-compatible audio drivers, a camera framework, and a TCP/IP stack.

A server is implemented as a computing node in a data center or edge computing environment. The server includes at least one central processing unit, at least one graphics processing unit or accelerator, volatile and non-volatile memory, storage devices, and a network interface. The server runs a server-class operating system and supports a deep learning framework such as a generic tensor computation framework (for example, PyTorch-type or TensorFlow-type implementation), a remote procedure call framework such as a gRPC-type implementation, and a database management system such as a relational database engine.

A user is a person such as a care receiver and/or a caregiver who is present near the terminal.

The user does not need to operate the terminal actively; rather, the user speaks, listens, and moves naturally, while the terminal and server perform the processing described below.

### B. Hardware and Software Configuration of the Terminal

The terminal uses the acoustic conversion unit to convert environmental sound into digital data. The acoustic conversion unit includes a microphone array composed of multiple omnidirectional or directional microphones, an analog front-end, and an analog-to-digital converter on an audio codec chip. The terminal configures an audio driver such as an ALSA-compatible driver to sample the microphone input at, for example, 16 kHz and 16-bit resolution, and to provide multi-channel pulse-code-modulated audio frames to an application process.

The terminal uses a beamforming library functionally similar to a WebRTC Audio Processing library to implement spatial signal processing. The terminal initializes the beamformer with array geometry (for example, microphone positions in centimeters) and a target direction of arrival. The beamformer computes time delays and weighting coefficients for each channel and applies a delay-and-sum or minimum-variance-distortionless-response algorithm. This spatial processing produces a direction-emphasized audio signal in which speech from a caregiver's location is strengthened relative to off-axis sources such as a television. By concentrating energy from a specific direction, the terminal reduces the amount of irrelevant data that must be transmitted to the server, thereby reducing communication load and improving processing efficiency.

The terminal uses a digital signal processing library such as an FFT library included in FFmpeg or a general-purpose numerical computation library to perform frequency-domain processing. The terminal segments the direction-emphasized audio into overlapping frames, applies a window function, and computes a fast Fourier transform for each frame. The terminal reads hearing characteristic information from non-volatile storage. The hearing characteristic information is stored as a data structure, for example, a table mapping center frequencies to gain factors or as a parameterization of a hearing threshold curve. The terminal constructs a gain vector aligned to FFT frequency bins and multiplies the complex spectrum element-wise by the gain vector to perform band-dependent amplification or attenuation. The terminal then applies inverse FFT and overlap-add to reconstruct a preprocessed audio signal with user-specific frequency emphasis. This step improves intelligibility while avoiding simple uniform amplification that could saturate noise or uncomfortable bands.

The terminal uses a noise suppression module, for example a module functionally comparable to a noise suppression component of the WebRTC Audio Processing library, to further improve signal-to-noise ratio. The noise suppression module maintains an estimate of the noise power spectral density and applies a suppression rule such as Wiener filtering or spectral subtraction. Because the gain profile is applied before noise suppression, the module can focus suppression on bands that are both noisy and not critical for speech intelligibility, thereby improving overall clarity and reducing computational waste.

The terminal uses a camera module, for example controlled via a V4L2-type interface or a Camera2-type API, to capture facial images of the user. The terminal applies a computer vision library, for example a library comparable to OpenCV, to detect face regions and align them. The terminal resizes a face patch to a fixed dimension such as 128×128 pixels and normalizes pixel intensities.

The terminal executes a lightweight convolutional neural network through a runtime such as TensorFlow Lite. The CNN includes, for example, several convolutional layers with rectified linear unit activations, pooling layers, and fully connected layers, and outputs a probability distribution over simple facial expression categories (e.g., neutral, smile, frown). The CNN is trained offline using a supervised learning method. During training, the server uses a dataset of labeled facial expressions, a cross-entropy loss function, stochastic gradient descent or an adaptive optimizer, and data augmentation such as random cropping and brightness jitter. The trained weights are deployed to the terminal. The terminal runs only inference; it multiplies input tensors by stored weight matrices and applies nonlinearities. This architecture improves the robustness of emotion estimation compared to rule-based facial feature heuristics and can operate in real time on limited hardware.

The terminal also computes audio features using an audio feature extraction library functionally similar to an OpenSMILE implementation. The terminal extracts acoustic descriptors such as fundamental frequency, energy, spectral slope, Mel-frequency cepstral coefficients, and their statistics over time. The extracted features are stored in arrays or tensors that represent the audio feature.

The terminal acquires environmental state information from local sensors and system components. The environmental state information includes, for example, a noise-level estimate obtained from a non-directional microphone channel, a time-of-day value obtained from a system clock, and an illumination level obtained from a photometric sensor. The terminal constructs a structured data object, such as a JSON object, that includes fields for the audio feature, the facial expression category, and the environmental values. This object is designated as emotion feature data.

The terminal uses a communication stack and a client library such as a gRPC-type client to transmit audio and emotion feature data to the server. The terminal encodes the preprocessed audio signal using an audio codec such as an Opus-type codec to compress the data while preserving intelligible speech. The terminal attaches sequence numbers and timestamps in a defined data structure so that the server can reconstruct temporal relationships between audio and emotion features.

The terminal also includes multi-modal output devices. The terminal uses an audio playback API such as AudioTrack-type or PulseAudio-type APIs to send decoded audio frames to a loudspeaker or earphone. The terminal uses a user interface framework such as a modern UI toolkit to display text at large font sizes and high contrast. The terminal uses a vibration control interface such as a Vibrator-type API to generate tactile feedback patterns. These components are controlled by the terminal according to metadata derived from the server's processing, including emotional state metadata.

### C. Hardware and Software Configuration of the Server

The server receives streaming messages from one or more terminals via a gRPC-type server library over an IP network. The server decodes encoded audio frames using a software audio codec implementation such as a libopus-type library, reconstructing time-aligned PCM signals.

The server parses emotion feature data objects using a JSON parsing library or an equivalent structured data parser. The server maps facial expression labels to one-hot vectors, normalizes numeric environmental features, and passes all features into a learned multimodal inference model.

The server implements the multimodal inference model, for example, as a neural network defined in a deep learning framework. In one embodiment, the model consists of:
An audio sub-network: a sequence of fully connected layers with non-linear activations that transform the audio feature vector into a latent representation.
A visual sub-network: a small embedding layer that takes the one-hot facial expression vector as input and projects it into a latent space.
An environmental sub-network: a sequence of dense layers that process environmental scalar features such as noise level, time category, and illumination state.
A fusion layer: a concatenation of sub-network outputs followed by one or more fully connected layers with non-linearities and, optionally, attention or gating mechanisms.
An output layer: a softmax layer that produces probability values for multiple emotion categories, including at least calm, anxiety, confusion, fatigue, and depression.

The server trains the model in advance using labeled multimodal datasets. During training, the server uses a cross-entropy loss function, backpropagates gradients through the network, and updates weights using an optimizer such as stochastic gradient descent with momentum or an adaptive optimizer. The server optionally employs regularization techniques such as dropout and L2 weight decay, as well as data augmentation (for example, adding noise to audio features or perturbing environmental values) to improve generalization. Once trained, the server loads the model weights into memory and performs inference on a GPU, which substantially reduces latency when processing streams from multiple terminals.

The server stores historical emotion states and associated metadata in a relational database. This storage supports later trend analysis, but in the core processing loop the server uses only the current emotion inference and, optionally, a short-term history for smoothing.

The server also includes a speech-to-text module. In one embodiment, the server uses an automatic speech recognition engine such as a Whisper-type model or a cloud-based speech recognition API. The server passes segments of the preprocessed audio to this engine, receives a text transcript, and normalizes the transcript (for example, lowercasing, punctuation cleanup, time stamp stripping) to generate character information.

### D. Prompt Generation and Generative AI Control

The server uses a prompt generation module to produce a prompt sentence for a generative AI model. The server constructs an internal context object that includes the estimated emotional state, a confidence value, environmental state information, basic characteristics of the audio or text (for example, length or presence of overlapping TV sound), and the intended output modality. The server selects a template according to rule-based logic coded in the server. For example, the server applies rules such as:
If emotional state is anxiety and environmental noise level is high, then select a template emphasizing noise suppression, speech enhancement, and slower speech rate.
If emotional state is confusion and the transcript length exceeds a threshold, then select a template emphasizing segmentation and simplification of content.

The server fills the selected template with the context values, for example, inserting the words “anxious” or “confused,” and descriptions of environmental conditions. The server thus produces a prompt sentence in natural language that instructs a generative AI model how to transform or generate output. The prompt generation is not a static mapping; it is a dynamic process in which the server computes prompt content as a function of current multimodal input, which differs from manually crafted prompts used in conventional systems.

For example, the server may generate the following prompt sentence when the user is anxious and the television is loud:

“The user is an elderly care receiver and is currently in an anxious state. There is loud television sound in the environment. The following audio data contains both television sound and the caregiver's voice. Extract only the caregiver's utterances, emphasize the caregiver's voice so that it is clear and gentle in tone, and suppress the background television sound as much as possible. Emphasize high-frequency components moderately so that the audio is easy for elderly listeners to understand, and slow down any parts that are spoken too quickly before outputting the final audio.”

In another situation, where the user is confused and the caregiver's explanation is long, the server may generate:

“The user is in a confused state and has difficulty understanding long sentences at once. The following text is an explanation given by a caregiver to the care receiver. Split this text into short sentences of at most about 20 characters, place the most important instructions at the beginning of each sentence, and rewrite the content in simple, easy-to-understand language. Output the result as a list of short sentences.”

The server uses a generative AI model that, in one embodiment, is a transformer-based large language model. The model consists of multiple layers of self-attention mechanisms and feed-forward networks, and is trained on large corpora of text for next-token prediction. In some embodiments, the model is fine-tuned on domain-specific data, such as caregiver-patient dialogues, using supervised fine-tuning or reinforcement learning with human feedback, thereby biasing the model toward clear, polite, and concise instructions.

During inference, the server sends as input the concatenation of the prompt sentence and the character information (e.g., the transcript of caregiver speech) encoded as token sequences.

The model computes high-dimensional vector representations at each layer, applies attention weight matrices to relate tokens to each other, and generates probability distributions for the next token at each step. The server samples or greedily selects tokens to generate an output sequence that satisfies the instructions in the prompt sentence. Because the prompt sentence encodes specific operational constraints (speech rate, simplification, emphasis), the resulting text is structurally different from the original caregiver speech and is optimized for the user's current state.

This approach provides an improvement over conventional use of generative models because the server automatically and systematically constructs prompt sentences based on algorithmically derived emotional and environmental context, rather than relying on static, hand-crafted prompts. As a result, the generative AI model is integrated into a control loop that is part of the system's technical architecture.

### E. Generation of Converted Audio and Multi-Modal Outputs

The server processes the generative AI output text to generate both audio and subtitle content. The server segments the generated text into sentences or clauses based on punctuation and length constraints. The server sends each sentence to a text-to-speech engine that may be a parametric synthesizer or a neural vocoder-based system. The engine converts text into audio waveforms. Parameters such as speaking rate, prosody, and pitch are selected according to the emotional state and environmental information. For example, the server configures the TTS engine to slow down the speech rate and use a gentle intonation when the user is anxious, and to keep the rate moderate when the user is calm.

The server measures or estimates the duration of each synthesized audio segment. The server associates each sentence with a display interval, forming subtitle entries consisting of text and timing information. The server packages the converted audio data and the subtitle data into messages, along with emotional state metadata such as “anxious; caregiver speech emphasized; TV noise suppressed,” and sends these messages back to the terminal. The server encodes the audio using an audio codec to reduce bandwidth.

The terminal receives the messages, decodes the audio back into PCM, and presents it through the speaker. The terminal parses the subtitle timing and renders the subtitles on the display, for example as large, high-contrast text at the bottom of the screen. The terminal reads the emotional state metadata and automatically adjusts parameters such as output sound volume, subtitle display timing margins, and vibration intensity or pattern. For example, if the metadata indicates a high level of anxiety, the terminal may raise the audio volume slightly and display subtitles for a longer period; if the metadata indicates fatigue, the terminal may avoid loud bursts and use softer vibrations.

### F. Technical Effect and Improvement of Computer Technology

The server and the terminal perform a sequence of computational operations on specifically structured data, including multi-channel audio frames, feature tensors, emotion feature objects, prompt templates, and generative AI tokens. The integration of spatial audio processing, user-specific hearing compensation, noise suppression, multimodal emotion inference, dynamic prompt generation, and generative AI-based transformation produces several technical effects.

First, the system reduces communication and computation overhead by emphasizing relevant sound sources and suppressing irrelevant ones before transmission. The beamforming, FFT-based gain correction, and noise suppression executed at the terminal ensure that the server receives signals with a higher signal-to-noise ratio and narrower effective bandwidth. This enables the server to process audio more quickly and accurately, especially in multi-user scenarios.

Second, the multimodal inference model improves accuracy of emotion estimation compared to single-modality or rule-based approaches. By fusing audio features, facial expressions, and environmental state information through a learned neural architecture, the server can infer emotional states that would not be reliably detectable from any single input. This in turn allows the system to adjust processing conditions precisely, leading to more effective generative transformations and fewer unnecessary operations.

Third, the dynamic prompt generation mechanism improves the efficiency and reliability of generative AI usage. Instead of manual prompt design, the server algorithmically constructs prompt sentences that encode explicit transformation instructions. This reduces the need for repeated user trial-and-error, avoids ambiguous instructions, and ensures that the generative AI model's computational resources are focused on transformations that are known, by prior system design, to improve intelligibility for the current context.

Fourth, the integrated control of audio, visual, and tactile outputs based on emotional state metadata provides a hardware-level improvement. The terminal automatically adjusts audio gain, screen rendering parameters, and haptic intensity in real time based on metadata from the server. This is a control loop that spans network communication, server inference, and terminal hardware drivers, and it is not achievable through simple manual volume adjustments or static OS-level accessibility settings.

Fifth, the training and deployment methodology of the neural models results in improved performance. The server uses defined loss functions (e.g., cross-entropy), gradient-based optimization, and data augmentation strategies to produce robust models that generalize across noise conditions and user variations. The models are then deployed in a quantized or optimized form suitable for GPU or CPU execution, reducing latency and energy consumption.

Finally, the system processes data according to rules and architectures that are different from conventional human tasks. For example, no human caregiver can continuously integrate multi-channel microphone arrays, facial expression tensors, noise measurements, and database-stored hearing profiles to generate consistent prompt sentences for a generative AI model and adjust speech rate and noise suppression algorithmically at millisecond time scales. The described system applies non-conventional, algorithmic rules to data structures specifically designed for machine processing, thereby improving the functioning of the computer system as a whole, including speed, accuracy, and resource utilization.

### G. Alternative Embodiments and Variations

The server may use different neural network architectures for emotion inference, such as recurrent neural networks, temporal convolutional networks, or transformer-based models that process sequences of features over time. The generative AI model may be hosted locally on the server or accessed via a remote API. The prompt generation logic may include additional conditions, such as long-term emotion trends or user preferences stored in a profile.

The terminal may include additional sensors, such as a heart-rate sensor or a motion sensor, and append these readings to the environmental state information. The hearing characteristic information may be updated periodically based on audiometric tests. The system may support different languages by switching templates and using language-specific generative models and TTS engines.

The above embodiments are illustrative and not limiting. The server and the terminal can be configured with equivalent components and software stacks that implement the claimed functions, while maintaining the overall architecture of acquiring multi-channel audio, performing user-specific signal processing, inferring emotional state via a multimodal model, generating context-dependent prompt sentences, controlling a generative AI model, and rendering multi-modal outputs based on emotional state metadata.

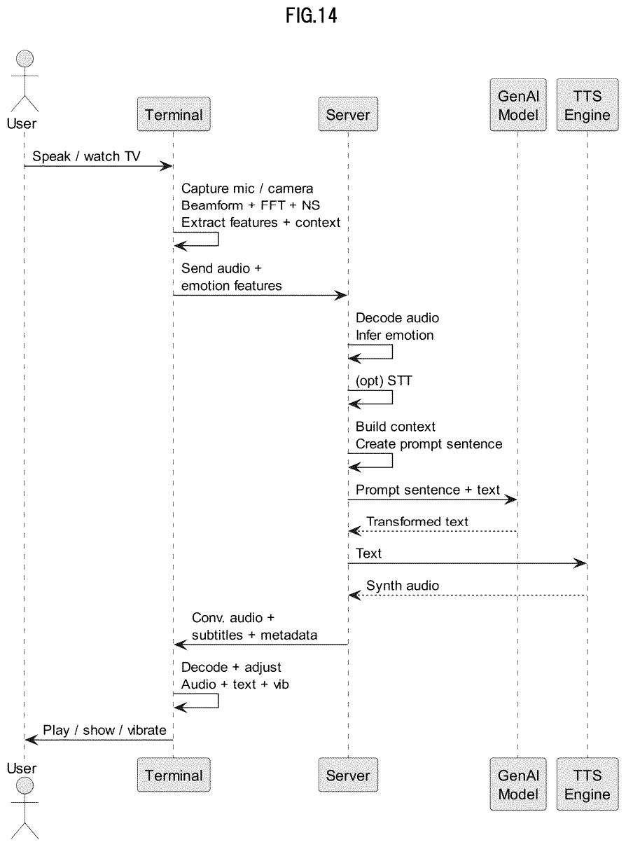

The following describes the processing flow using FIG. 14.

### Step 1:

Terminal acquires multi-channel audio from the environment.

Terminal uses the acoustic conversion unit as input, receiving analog sound waves including caregiver speech, television sound, and other noises. Terminal converts the analog signals from multiple microphones into digital samples via an A/D converter, and the audio driver delivers interleaved multi-channel PCM frames to application memory. Based on this input, Terminal generates as output a time-stamped multi-channel audio buffer that is ready for spatial signal processing.

### Step 2:

Terminal performs beamforming to emphasize a target direction.

Terminal takes as input the multi-channel audio buffer and the known microphone array geometry and target direction parameters. Terminal applies a beamforming algorithm, computing time delays and weights for each channel, and then executes delay-and-sum or related spatial filtering operations. By adding the delayed and weighted channels, Terminal suppresses off-axis sounds and enhances sounds arriving from the caregiver's direction. Terminal outputs a single-channel direction-emphasized PCM stream with associated timestamps.

### Step 3:

Terminal applies hearing-profile-based frequency correction.

Terminal receives as input the direction-emphasized PCM stream and user-specific hearing characteristic information stored in non-volatile memory. Terminal segments the PCM stream into overlapping frames, applies a window function, and executes an FFT on each frame to obtain a complex spectrum. Terminal then constructs a gain vector from the hearing characteristic information and multiplies each spectrum bin by the corresponding gain factor, amplifying or attenuating particular bands. After this data operation, Terminal performs inverse FFT and overlap-add to reconstruct the signal. Terminal outputs a hearing-compensated PCM stream in which frequency components are adjusted to match the user's hearing profile.

### Step 4:

Terminal suppresses steady background noise.

Terminal takes the hearing-compensated PCM stream as input. Terminal uses a noise suppression module to estimate noise power spectra over time and applies spectral subtraction or Wiener filtering per frame. Terminal modifies the spectral magnitude to reduce components identified as noise while leaving speech components relatively intact. Terminal then reconstructs time-domain frames and merges them to form a cleaned audio signal. The output is a noise-suppressed PCM stream with improved signal-to-noise ratio and retained timing information.

### Step 5:

Terminal extracts audio features related to emotion.

Terminal uses the noise-suppressed PCM stream as input. Terminal divides the stream into analysis windows and computes low-level descriptors such as pitch, energy, zero-crossing rate, and Mel-frequency cepstral coefficients using an audio feature extraction library.

Terminal aggregates these values over defined time spans by calculating means, variances, and other statistics. Through these numerical operations, Terminal transforms raw audio samples into a structured audio feature vector. Terminal outputs this audio feature vector for use in emotion estimation.

### Step 6:

Terminal captures facial images and derives facial expression information.

Terminal uses the camera sensor as input to capture frames containing the user's face.

Terminal applies a vision library to detect a face bounding box within each frame, crops that region, resizes it to a fixed dimension, and normalizes pixel values. Terminal then feeds the resulting tensor into a lightweight convolutional neural network. The CNN performs a sequence of matrix multiplications and non-linear activations to compute probabilities for expression categories. Terminal selects the category with the highest probability as the simple facial expression label. The output of this step is a facial expression label and, optionally, intermediate confidence scores.

### Step 7:

Terminal collects environmental state information.

Terminal receives as input sensor readings and system values, including ambient noise level from a non-directional microphone, time of day from the system clock, and light intensity from an illumination sensor. Terminal normalizes these values, for example by mapping them into predefined ranges or categories (such as low, medium, high). Terminal then constructs an environmental state vector representing the current context. The output is a structured set of environmental parameters associated with the current time window.

### Step 8:

Terminal constructs emotion feature data.

Terminal takes as input the audio feature vector, the facial expression label, and the environmental state vector. Terminal organizes these values into a defined data structure, such as a JSON object or equivalent, with fields for each feature group. Terminal adds timestamps and identifiers so that the data can be aligned with the corresponding audio segment. By this data structuring operation, Terminal generates emotion feature data that encapsulates multimodal information for a specific time interval. Terminal outputs this emotion feature data for transmission.

### Step 9:

Terminal encodes audio and transmits data to the server.

Terminal uses the noise-suppressed PCM stream and the emotion feature data as input.

Terminal encodes the PCM stream into compressed audio frames using an audio codec, assigning sequence numbers and timestamps to each frame. Terminal packages the encoded audio frames together with emotion feature data into messages defined by a remote procedure call schema. Terminal then sends these messages over a network via a client library and a wireless modem. The output of this step is a continuous stream of encoded audio packets and synchronized emotion feature messages delivered to the server.

### Step 10:

Server receives and reconstructs audio and emotion feature data.

Server accepts the incoming message stream as input via a server-side RPC framework.

Server separates audio packets from emotion feature messages according to the message schema. Server decodes the audio packets using an audio codec library to reconstruct PCM frames with original timing. Server parses the emotion feature data, extracting the audio feature vector, facial expression label, and environmental state vector. As output, Server maintains aligned PCM buffers and corresponding multimodal feature tensors for further processing.

### Step 11:

Server estimates the user's emotional state using a multimodal model.

Server uses the audio feature vector, facial expression label, and environmental state vector as input. Server encodes the label into a one-hot vector, normalizes numeric features, and concatenates all features into a single multimodal input tensor. Server feeds this tensor into a trained neural network that includes audio, visual, and environmental sub-networks and fusion layers. The network applies linear transformations, non-linear activations, and possibly attention mechanisms to compute a probability distribution over emotion categories. Server selects the category with the highest probability as the emotional state and records the associated probability as a confidence score. Server outputs the estimated emotional state, the confidence value, and optionally smoothed or historical context.

### Step 12:

Server optionally transcribes caregiver speech into text.

Server uses as input the reconstructed PCM audio corresponding to a relevant time window.

Server passes this audio to a speech-to-text engine, which applies acoustic and language models to decode spoken words. Server receives the transcription, cleans it (for example, removing filler words or normalizing punctuation), and stores it as character information. The output of this step is a text representation of caregiver speech that can be further processed or simplified.

### Step 13:

Server prepares context data for prompt generation.

Server takes as input the emotional state, the confidence score, the environmental state vector, and any available character information. Server evaluates rule conditions (for example, anxiety with high noise, confusion with long explanation) and sets context flags. Server compiles a context object containing all relevant fields, such as current emotion category, noise level, time category, and whether the text is considered long or complex. The output is a structured context object ready for use by the prompt generation logic.

### Step 14:

Server generates a prompt sentence for the generative AI model.

Server receives the context object and any character information as input. Server selects a prompt template according to rule-based logic; for example, selecting a “noise suppression and slowing” template when the user is anxious in a noisy environment. Server replaces placeholders in the template with actual context values (such as emotion labels and environmental descriptors) to form a concrete prompt sentence. By combining rule selection and template filling operations, Server outputs a prompt sentence in natural language that instructs the generative AI model how to process the upcoming text or audio.

### Step 15:

Server submits the prompt sentence and text to the generative AI model.

Server takes as input the prompt sentence and the character information (for example, the transcript of caregiver speech). Server concatenates the prompt sentence and the character information with appropriate separators and encodes them as tokens for the generative AI model. Server sends this token sequence to the model via an API or local inference engine.

The model performs internal transformer computations-self-attention, feed-forward projections, and probabilistic token selection—to generate a new sequence of tokens. Server decodes the tokens into text. The output of this step is a transformed text that reflects instructions in the prompt sentence, such as segmented, simplified, or reordered caregiver instructions.

### Step 16:

Server generates converted audio and subtitle timing from generative-AI text.

Server uses the transformed text as input. Server splits the text into short sentences or segments based on punctuation and length rules. For each segment, Server calls a text-to-speech engine with parameters such as speech rate and voice style derived from the emotional state. The engine returns audio waveforms for each segment. Server measures or receives each segment's duration, then associates each text segment with a start and end time to create subtitle entries. As output, Server produces converted audio data (one or more synthesized audio segments, optionally concatenated) and a list of subtitle entries with synchronized timing.

### Step 17:

Server encodes results and sends them back to the terminal.

Server takes as input the converted audio data, the subtitle entries, and the emotional state information. Server encodes the converted audio into compressed frames using an audio codec. Server packages the encoded audio, subtitle text with timing, and emotional state metadata into response messages defined by the RPC schema. Server sends these messages over the network stream back to the terminal. The output of this step is a sequence of response packets that carry all necessary information for multi-modal presentation.

### Step 18:

Terminal presents audio, visual, and tactile outputs to the user.

Terminal uses as input the response packets from the server. Terminal decodes the converted audio frames into PCM and passes them to the speaker or earphones, adjusting volume based on emotional state metadata. Terminal parses the subtitle entries and schedules their display on the screen, rendering them as large, high-contrast text during the specified time intervals. Terminal examines the notification type and emotional state metadata to decide whether to trigger vibration, and, if so, sends control signals to the vibration actuator to produce a defined pattern. The outputs of this step are audible caregiver instructions, corresponding readable subtitles, and optional tactile alerts, all synchronized and adapted to the user's emotional and environmental context.

### Step 19:

User receives and reacts to the adapted information.

User is exposed to the converted audio, displayed subtitles, and any tactile feedback as inputs. Based on these outputs, User hears clearer caregiver speech, reads concise and simplified instructions, and perceives important events through vibration when necessary. Without needing to operate any controls, User can understand essential information more reliably, even under hearing limitations or in noisy environments.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

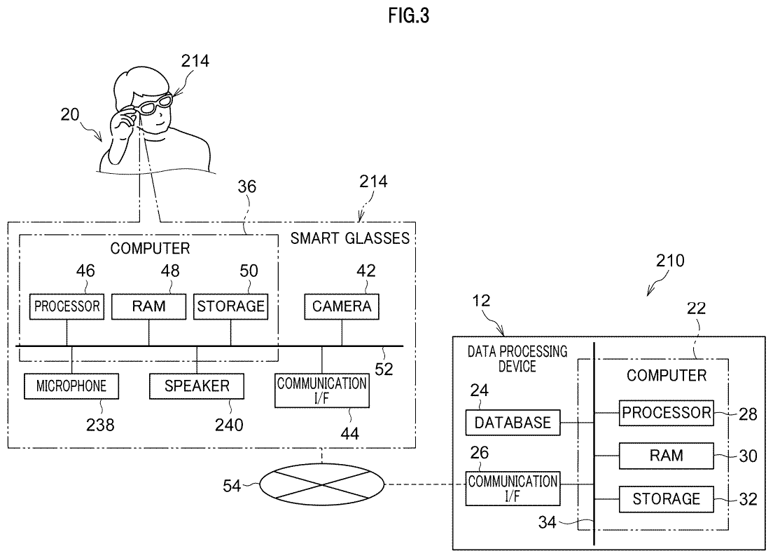

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34.

The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

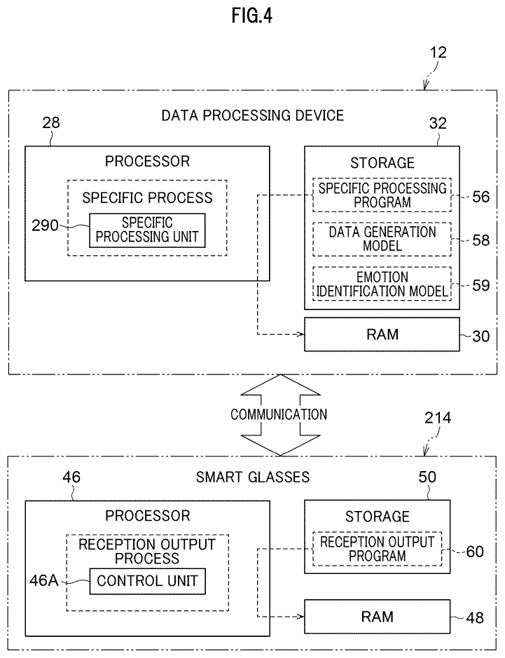

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

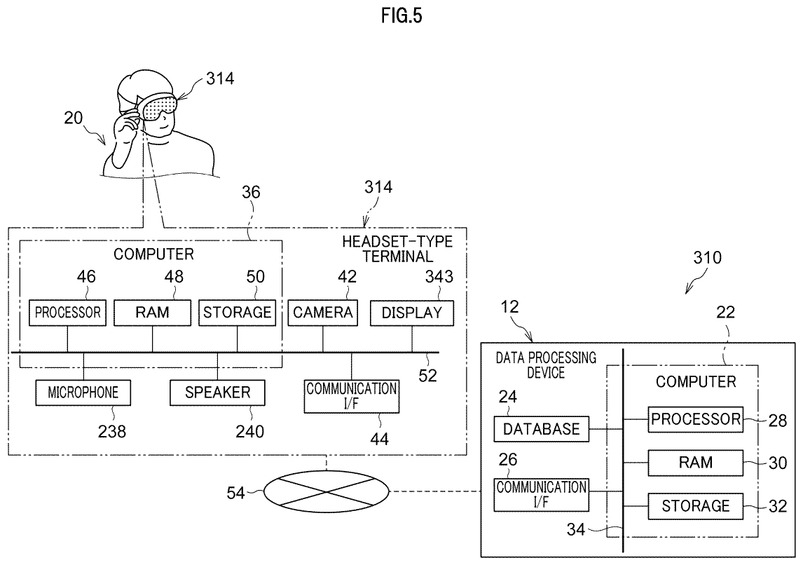

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

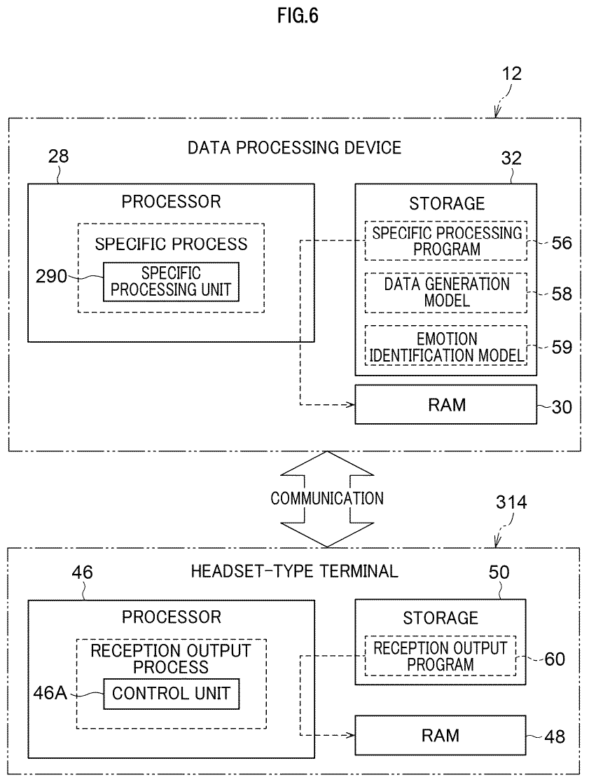

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

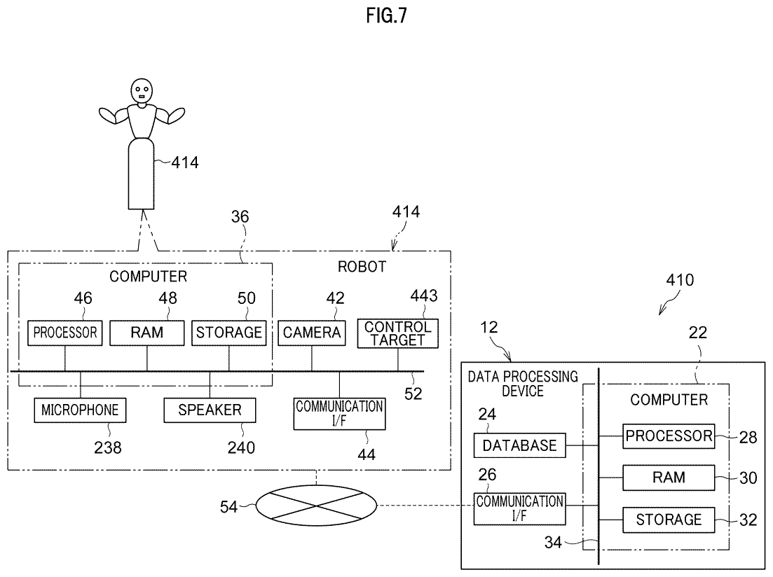

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

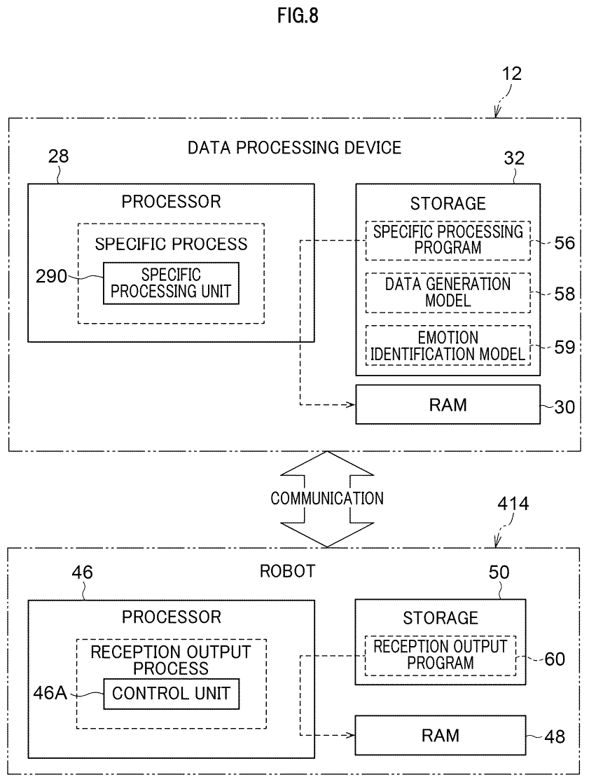

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

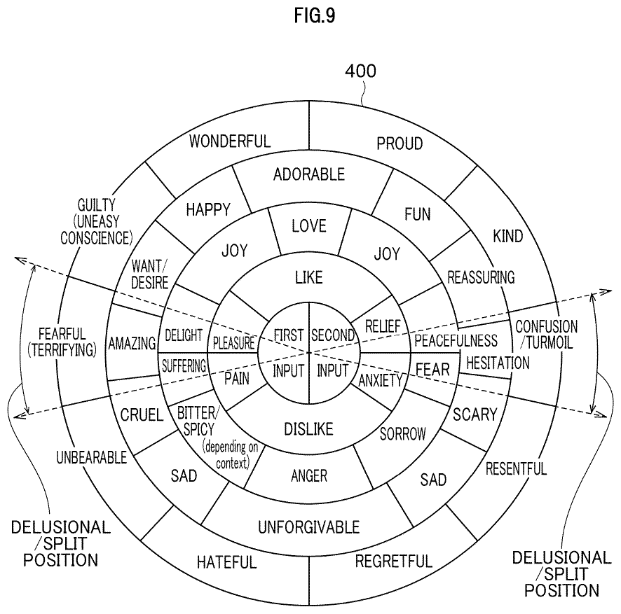

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

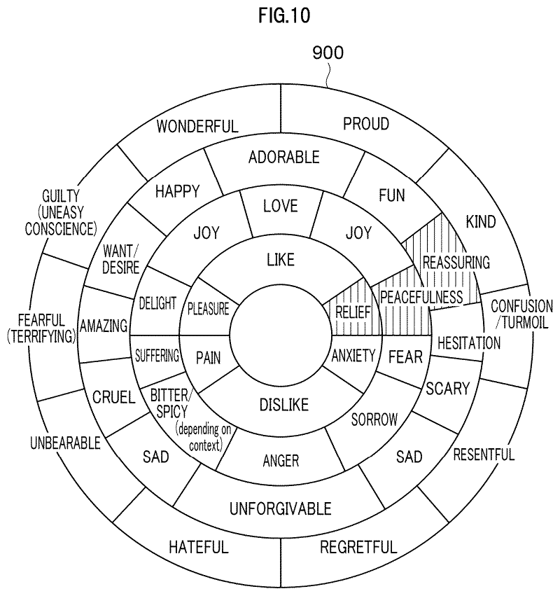

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire external acoustic information from an input apparatus and generate audio data,
perform signal processing on the audio data to remove environmental noise and to emphasize a direction of an acoustic source,
segment the signal-processed audio data into time frames and calculate feature information including frequency information and loudness information for each time frame,
generate text information including the feature information and user attribute information, and supply the text information as a prompt sentence to a generative AI model,
receive, from the generative AI model, structured instruction information including at least one of a frequency band emphasis parameter, a noise suppression parameter, a loudness parameter, a pitch correction parameter, a language conversion parameter, a visual presentation parameter, and a haptic presentation parameter,
convert the audio data based on the structured instruction information by executing at least one processing selected from equalization processing, dynamic range control processing, pitch conversion processing, speech synthesis processing, translation processing, and summarization processing, so as to generate enhanced audio information that is intelligible to a user,
control an audio output apparatus configured to reproduce the enhanced audio information, a display apparatus configured to present at least one of character information, graphic information, and light information based on the structured instruction information, and a haptic output apparatus configured to output vibration information based on the structured instruction information,
transmit the audio data and the structured instruction information to an external information processing apparatus including the generative AI model, and receive processed information from the external information processing apparatus, via a mobile communication network, in a sequential manner so as to maintain real-time performance,
receive, from the user, setting information including at least one of environment type, listening purpose, preferred frequency band, target translation language, and notification mode via visual and haptic outputs, and a natural-language prompt sentence, and supply the prompt sentence to the generative AI model to dynamically update the structured instruction information, and
store the setting information and the structured instruction information for each user, and automatically change processing conditions for subsequent audio data based on stored information.

### (Supplementary 2)

The system according to supplementary 1,
wherein the processor is configured to
in an educational environment, perform source localization processing and directivity formation processing on audio data from a plurality of input apparatuses in order to emphasize acoustic information from a main speaker direction and suppress acoustic information from a background noise direction,
supply a prompt sentence including requirement conditions relating to improvement of intelligibility of main speaker speech and suppression of background noise to the generative AI model, obtain, as the structured instruction information, at least a frequency band emphasis amount for a frequency band including consonant components of the main speaker speech and an allowable delay amount, and
based on the structured instruction information, adjust at least one of timbre, loudness, and pitch of the main speaker speech and suppress utterance components of non-main speakers such that the user can preferentially listen to the main speaker speech, and
perform classification processing on the audio data after the signal processing to identify an event including at least one of an alarm sound, a warning sound, and an emergency broadcast, and when the event is detected, control the display apparatus to present a high-visibility display and control the haptic output apparatus to output a predetermined vibration pattern, based on the structured instruction information acquired from the generative AI model, so as to notify a hearing-impaired user of important acoustic information.

### (Supplementary 3)

The system according to supplementary 1,
wherein the processor is configured to
generate a plurality of presentation modes each including at least one of audio reproduction of the enhanced audio information, display of character information, and output of haptic information, based on the structured instruction information acquired from the generative AI model, and switch between the plurality of presentation modes in accordance with the setting information of the user,
transmit and receive, via the mobile communication network, the audio data, the character information, the structured instruction information, and alert control information as multiplexed independent logical channels to and from the external information processing apparatus, monitor at least one of delay time and transmission quality, and dynamically simplify at least one of processing content and data amount based on the structured instruction information so that the user continuously receives the audio information and the visual and haptic information, and
when the prompt sentence supplied to the generative AI model is sequentially updated by the user, regenerate the structured instruction information and change subsequent audio processing and presentation modes in real time based on the regenerated structured instruction information.

### Application Example 1

### (Supplementary 1)

A system comprising a processor,
wherein the processor is configured to
acquire an external audio signal via an audio acquisition unit, analyze the acquired audio signal in a time domain or a frequency domain, and extract a plurality of acoustic feature values from the acquired audio signal while performing audio enhancement processing and noise suppression processing based on hearing characteristic information of a user and environmental information,
generate additional information associated with the audio signal and the acoustic feature values, the additional information including at least sound source type information, signal-to-noise ratio information, time information, and user profile information,
compress the audio signal and the additional information according to a predetermined encoding scheme and transmit the compressed audio signal and the additional information to an external processing apparatus via a mobile communication network,
in the external processing apparatus, generate a prompt sentence described in a natural language that represents an audio processing policy based on the additional information and the user profile information, input the prompt sentence and feature values based on the audio signal to a generative AI model, and execute at least one of audio conversion processing and audio enhancement processing by the generative AI model so as to generate a processed audio signal optimized for the user and related information,
receive, via the mobile communication network, the processed audio signal generated by the external processing apparatus, decode the processed audio signal, and convert the decoded processed audio signal into at least one of an audio output for listening, a visual display information, and a haptic presentation control signal,
control an audio output unit to output the audio output for listening, control a visual presentation unit to display the visual display information, and control a haptic presentation unit to generate vibration or another haptic stimulus based on the haptic presentation control signal, and
receive user setting information including at least a degree of emphasis for a high-frequency band, a degree of suppression for background noise, presence or absence of translation processing, presence or absence of subtitle display, and a notification mode for each type of important sound, transmit the user setting information to the external processing apparatus, and cause the external processing apparatus to dynamically change the prompt sentence and processing conditions of the generative AI model based on the user setting information.

### (Supplementary 2)

The system according to supplementary 1,
wherein the processor is configured to
in an educational environment or a similar environment, extract audio feature values from the acquired audio signal by time-frequency analysis in order to distinguish speaker voice from other environmental sounds, perform directional formation processing and noise suppression processing to prioritize the speaker voice, detect important sounds including at least siren sounds, alarm sounds, and calling sounds, include event information corresponding to the detected important sounds in the additional information, transmit the additional information to the external processing apparatus, and cause the external processing apparatus, based on the event information and the prompt sentence, to generate a processed audio signal in which the important sounds are emphasized, a visual display information corresponding to each type of important sound, and a haptic presentation control signal corresponding to each type of important sound.

### (Supplementary 3)

The system according to supplementary 1,
wherein the processor is configured to
perform real-time feedback while synchronizing the audio output and subtitles included in the visual display information based on time information of the processed audio signal sequentially transmitted from the external processing apparatus, individually change a display style of the subtitles, a form of visual notification, and a pattern and an intensity of haptic presentation according to the user setting information, and, by using the mobile communication network for low-latency and high-speed bidirectional communication to transmit and receive the prompt sentence and the processed audio signal, enable the user to continuously perceive external audio without interruption.

### Example 2

### (Supplementary 1)

A system comprising a processor,
wherein the processor is configured to
acquire external audio by controlling an acoustic input unit and to acquire user speech separately from the external audio and generate audio feature data based on the user speech,
perform signal processing including noise reduction processing and directivity control processing on the external audio to generate preprocessed audio data,
estimate an emotional state of a user based on the audio feature data,
store, in a storage device, a user profile including listening conditions and notification conditions for each user,
generate, based on the estimated emotional state, the user profile stored in the storage device, and current usage-scene information, a prompt sentence that describes in a natural language processing contents, output formats, and constraint conditions to be given to a generative AI model,
input the prompt sentence and at least one of the preprocessed audio data and text data obtained from the preprocessed audio data into the generative AI model and obtain from the generative AI model audio processing parameters, visual-presentation text information, and notification control information,
execute, based on the audio processing parameters, audio conversion processing including speaking-rate adjustment processing, volume adjustment processing, and frequency-characteristic adjustment processing to generate converted audio data, and
control, based on the visual-presentation text information and the notification control information, at least one of an acoustic output unit, a visual output unit, and a haptic output unit to perform at least one of audio output, visual output, and haptic output.

### (Supplementary 2)

The system according to supplementary 1,
wherein the processor is configured to, in an educational scene when the emotional state of the user is estimated to be a confused state, generate the prompt sentence so as to instruct the generative AI model to calculate time-stretching parameters for reducing a speaking rate of a teacher's utterance by a predetermined ratio, calculate segment-wise gain control parameters for increasing a volume of audio segments including important words by a predetermined amount, and generate visual-presentation text information that expresses key points of the utterance within a predetermined number of lines, obtain the time-stretching parameters, the gain control parameters, and the visual-presentation text information from the generative AI model, convert the teacher's utterance audio into audio that is easier for the user to understand based on the time-stretching parameters and the gain control parameters, and present the converted audio data and the visual-presentation text information in synchronization.

### (Supplementary 3)

The system according to supplementary 1,
wherein the processor is configured to, in a public-space scene when the emotional state of the user is estimated to be an anxious state, generate the prompt sentence so as to instruct the generative AI model to detect segments of alarm sounds and emergency-guidance speech in the external audio, generate simplified text information representing contents of the alarm sounds and the emergency-guidance speech, and generate the notification control information for performing notification using visual output and haptic output while avoiding excessive increase of audio volume, obtain the notification control information and the simplified text information from the generative AI model, and perform control such that, based on the notification control information, an audio output level is suppressed and notification is provided by screen display and weak haptic output.

### Application Example 2

### (Supplementary 1)

A system comprising a processor,
wherein the processor is configured to
acquire external sound through an acoustic conversion unit and generate multi-channel audio signals,
perform spatial signal processing on the multi-channel audio signals to emphasize a sound component from a predetermined direction and to output a direction-emphasized audio signal, perform frequency analysis on the direction-emphasized audio signal, refer to hearing characteristic information stored for each user, and execute gain correction for respective frequency bands and noise suppression so as to generate a preprocessed audio signal adapted to the user's hearing characteristics,
estimate an emotional state of the user based on at least one of the preprocessed audio signal, a facial image of the user, an audio feature of the user, and environmental state information, generate instruction information for constructing a prompt sentence to be input to a generative AI model, based on the estimated emotional state and on at least one of the preprocessed audio signal and character information generated from the preprocessed audio signal, control the generative AI model by inputting the prompt sentence and at least one of the preprocessed audio signal and the character information to the generative AI model so as to cause the generative AI model to execute a conversion process or a generation process for audio information, the conversion process or the generation process including at least one of enhancement of speech, conversion of speech rate, simplification of content, and suppression of background sound in accordance with the emotional state and the environmental state information, and to thereby generate converted audio data or converted character data, and output the converted audio data as auditory stimulation and output the converted character data as at least one of visual information and tactile information so as to provide audio-related information to the user through a plurality of modalities.

### (Supplementary 2)

The system according to supplementary 1,
wherein the processor is configured to
input, into a learned multimodal inference model, a multidimensional feature quantity including an acoustic feature extracted from the preprocessed audio signal, facial expression identification information generated from the facial image, and environmental state information including at least one of surrounding noise level, time zone, and illumination state, calculate probability values for a plurality of emotion categories including at least calm, anxiety, confusion, fatigue, and depression, output an emotion category having a maximum probability value as the emotional state, and, in accordance with the emotional state and the environmental state information, dynamically change at least a part of conditions for speech enhancement, speech rate, phrase simplification, and background sound suppression when generating the prompt sentence for the generative AI model.

### (Supplementary 3)

The system according to supplementary 1,
wherein the processor is configured to
decode encoded converted audio data using an audio codec and cause an acoustic output device to output the decoded audio as sound, associate the converted character data with time information and cause a display device to present subtitles with a large display format and a high-contrast display format, and, in accordance with at least one of a notification type and the emotional state, cause a tactile output device to output a vibration pattern and automatically adjust at least one of sound volume, display timing, and vibration intensity based on emotional state metadata.

What is claimed is:

1. A system comprising:
circuitry configured to:
acquire, via an input apparatus, signal data representing an external acoustic environment and generate digitized audio data from the signal data;
perform signal processing on the digitized audio data to suppress environmental noise components and segment the signal-processed audio data into time frames;
generate text information comprising feature information extracted from the time frames and user attribute information, and transmit the text information as a prompt sentence to a generative artificial intelligence model via a communication interface operating over a packet-switched network;
receive, from the generative artificial intelligence model, structured instruction information specifying at least adjustment parameters for the digitized audio data;
convert the digitized audio data based on the structured instruction information to generate enhanced output data; and
control an output apparatus to present the enhanced output data to a user.

2. The system according to claim 1, wherein the feature information comprises frequency information and loudness information calculated for each time frame of the signal-processed audio data.

3. The system according to claim 2, wherein the structured instruction information comprises at least one of a frequency band emphasis parameter, a noise suppression parameter, a loudness parameter, a pitch correction parameter, a language conversion parameter, a visual presentation parameter, and a haptic presentation parameter.

4. The system according to claim 3, wherein the converting of the digitized audio data comprises executing at least one processing selected from equalization processing, dynamic range control processing, pitch conversion processing, speech synthesis processing, translation processing, and summarization processing, based on the structured instruction information.

5. The system according to claim 4, wherein the output apparatus comprises at least one of an audio output apparatus configured to reproduce the enhanced output data as audio, a display apparatus configured to present at least one of character information, graphic information, and light information based on the structured instruction information, and a haptic output apparatus configured to output vibration information based on the structured instruction information.

6. The system according to claim 5, wherein the circuitry is further configured to perform source localization processing and directivity formation processing on the digitized audio data acquired from a plurality of input apparatuses to emphasize acoustic information from a main speaker direction and suppress acoustic information from a background noise direction.

7. The system according to claim 6, wherein the prompt sentence includes requirement conditions relating to improvement of intelligibility of main speaker speech and suppression of background noise, and the structured instruction information received from the generative artificial intelligence model specifies at least a frequency band emphasis amount for a frequency band including consonant components of the main speaker speech and an allowable delay amount.

8. The system according to claim 7, wherein the circuitry is further configured to, based on the structured instruction information, adjust at least one of timbre, loudness, and pitch of the main speaker speech and suppress utterance components from non-main speaker directions such that the user preferentially perceives the main speaker speech.

9. The system according to claim 5, wherein the circuitry is further configured to perform classification processing on the signal-processed audio data to identify an event comprising at least one of an alarm sound, a warning sound, and an emergency broadcast, and when the event is detected, control the display apparatus to present a high-visibility display and control the haptic output apparatus to output a predetermined vibration pattern based on the structured instruction information.

10. The system according to claim 1, wherein the circuitry is further configured to receive, from the user, setting information comprising at least one of an environment type, a listening purpose, a preferred frequency band, a target translation language, and a notification mode, and supply a natural-language prompt sentence incorporating the setting information to the generative artificial intelligence model to dynamically update the structured instruction information.

11. The system according to claim 10, wherein the circuitry is further configured to store the setting information and the structured instruction information for each user, and automatically change processing conditions for subsequent digitized audio data based on the stored information.

12. The system according to claim 11, wherein the circuitry is further configured to generate a plurality of presentation modes each comprising at least one of audio reproduction of the enhanced output data, display of character information, and output of haptic information based on the structured instruction information, and switch between the plurality of presentation modes in accordance with the setting information of the user.

13. The system according to claim 12, wherein when the prompt sentence is sequentially updated by the user, the circuitry is further configured to regenerate the structured instruction information and change subsequent audio processing and the presentation modes in real time based on the regenerated structured instruction information.

14. The system according to claim 1, wherein the circuitry is further configured to compress the digitized audio data and additional information comprising at least sound source type information, signal-to-noise ratio information, and time information according to a predetermined encoding scheme and transmit the compressed data to an external processing apparatus via the packet-switched network.

15. The system according to claim 14, wherein the external processing apparatus is configured to generate the prompt sentence based on the additional information and user profile information, input the prompt sentence and feature values derived from the digitized audio data to the generative artificial intelligence model, and execute at least one of audio conversion processing and audio enhancement processing to generate a processed audio signal optimized for the user.

16. The system according to claim 1, wherein the circuitry is further configured to estimate an emotional state of the user based on audio feature data derived from speech of the user, and generate the prompt sentence based on the estimated emotional state, a user profile stored in a storage device, and current usage-scene information.

17. The system according to claim 16, wherein when the estimated emotional state of the user indicates a confused state, the prompt sentence instructs the generative artificial intelligence model to calculate time-stretching parameters for reducing a speaking rate by a predetermined ratio and calculate segment-wise gain control parameters for increasing a volume of audio segments including important words by a predetermined amount, and the circuitry converts the digitized audio data based on the time-stretching parameters and the gain control parameters.

18. A system comprising:
circuitry configured to:
acquire, via an input apparatus comprising a plurality of microphones, signal data representing an external acoustic environment and generate multi-channel digitized audio data from the signal data;
perform signal processing on the multi-channel digitized audio data comprising source localization processing to determine a direction of an acoustic source, directivity formation processing to emphasize acoustic information from the determined direction, and noise suppression processing to attenuate environmental noise components, and segment the signal-processed audio data into time frames;
calculate feature information comprising frequency information and loudness information for each time frame, generate text information comprising the feature information and user attribute information, and transmit the text information as a prompt sentence to a generative artificial intelligence model via a communication interface operating over a packet-switched network using a transport layer security protocol;
receive, from the generative artificial intelligence model, structured instruction information comprising at least a frequency band emphasis parameter, a noise suppression parameter, a loudness parameter, and at least one of a pitch correction parameter, a visual presentation parameter, and a haptic presentation parameter;
convert the multi-channel digitized audio data based on the structured instruction information by executing at least one processing selected from equalization processing, dynamic range control processing, pitch conversion processing, and speech synthesis processing to generate enhanced output data;
perform classification processing on the signal-processed audio data to identify an event comprising at least one of an alarm sound, a warning sound, and an emergency broadcast;
control an audio output apparatus to reproduce the enhanced output data as audio, control a display apparatus to present at least one of character information and graphic information based on the structured instruction information, and when the event is identified, control a haptic output apparatus to output a predetermined vibration pattern; and
store, in a storage medium, the structured instruction information and user setting information comprising at least one of an environment type, a listening purpose, a preferred frequency band, and a notification mode, and automatically change processing conditions for subsequent audio data based on the stored information.

19. The system according to claim 18, wherein the circuitry is further configured to estimate an emotional state of the user based on audio feature data derived from speech of the user, generate the prompt sentence based on the estimated emotional state and the user setting information, and when the emotional state indicates an anxious state, receive from the generative artificial intelligence model notification control information for performing notification using the display apparatus and the haptic output apparatus while suppressing an audio output level.

20. A method performed by circuitry of a system, the method comprising:
acquiring, via an input apparatus, signal data representing an external acoustic environment and generating digitized audio data from the signal data;
performing signal processing on the digitized audio data to suppress environmental noise components and segmenting the signal-processed audio data into time frames;
generating text information comprising feature information extracted from the time frames and user attribute information, and transmitting the text information as a prompt sentence to a generative artificial intelligence model via a communication interface operating over a packet-switched network;
receiving, from the generative artificial intelligence model, structured instruction information specifying at least adjustment parameters for the digitized audio data;
converting the digitized audio data based on the structured instruction information to generate enhanced output data; and
controlling an output apparatus to present the enhanced output data to a user.
